(19) United States
(12) Patent Application Publication
(10) Pub. No.: US 2026/0285330 A1
(43) Pub. Date: Sep. 24, 2026

(54) SYSTEM

(71) Applicant: SoftBank Group Corp., Tokyo (JP)

(72) Inventor: Daisuke YOSHIDA, Tokyo (JP)

(73) Assignee: SoftBank Group Corp., Tokyo (JP)

(21) Appl. No.: 19/563,045

(22) Filed: Mar. 11, 2026

(30) Foreign Application Priority Data
Mar. 19, 2025 (JP) 2025-044998

(51) Int. Cl. B60W 50/02; G06F 40/40; G06N 3/0475; G06V 10/764; G06V 20/59; G06V 40/16; G06V 40/18; G06V 40/19; G10L 15/02; G10L 15/04; G10L 15/22; G10L 25/63

(52) U.S. Cl. CPC B60W 50/02; G06F 40/40; G06V 10/764; G06V 20/597; G06V 40/166; G06V 40/171; G06V 40/19; G06V 40/193; G10L 15/02; G10L 15/04; G10L 15/22; G10L 25/63; B60W 2540/21; B60W 2540/221; B60W 2540/225; G06N 3/0475

(57) ABSTRACT

A system includes a processor that is configured to collect voice data of a driver and use a prompt to instruct a generative artificial intelligence model to analyze a reaction speed, slurring, and a voice pattern based on the voice data, capture eye movements of the driver and analyze a gaze movement and a blinking frequency using an image processing technique based on the eye movements, and integrate analyzed voice data and eye movement data and determine presence or absence of alcohol consumption of the driver and a degree of influence of the alcohol consumption using a machine learning technique.

### CROSS-REFERENCE TO RELATED APPLICATION

This application is based on and claims priority under 35 USC 119 from Japanese Patent Application No. 2025-044998 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional technologies for preventing drunk driving primarily rely on breath alcohol sensors, simple reaction tests, or manual self-declarations by drivers. Such approaches suffer from several problems. First, hardware breathalyzers require direct contact or specific blowing actions and are often perceived as intrusive and cumbersome, leading to poor user compliance and attempts to bypass the system. Second, simple reaction tests and fixed questionnaires are limited in accuracy and are easily manipulated by a driver who is motivated to conceal alcohol consumption. Third, existing systems rarely integrate multimodal information such as both voice characteristics and eye movements, and therefore fail to robustly detect subtle signs of alcohol influence, particularly at borderline levels. Fourth, emotional state, such as stress, anger, or fatigue, can significantly affect speech patterns and eye behavior and may result in false positives or false negatives when not properly distinguished from alcohol-induced changes. Fifth, when a driver is determined to be under the influence of alcohol, many systems either do not automatically enforce a safety measure or do not provide a structured mechanism for third-party confirmation and consent, thus allowing unsafe engine start or placing an excessive burden on the driver to self-regulate. Accordingly, there is a need for a system that accurately determines the presence and degree of alcohol influence by integrating multimodal driver data, adjusts for emotional state, and reliably links the determination result to a safety mechanism that prevents an engine from being started by the driver alone, while optionally involving a third party for confirmation and consent.

### SUMMARY

In order to solve the above-described problems, a system is provided that comprises a processor configured to utilize generative artificial intelligence models, image processing techniques, and machine learning techniques in an integrated manner. The processor is configured to collect voice data of a driver and to use a prompt to instruct a generative artificial intelligence model to analyze reaction speed, slurring, and a voice pattern based on the collected voice data. The processor is further configured to capture eye movements of the driver, and to analyze a gaze movement and a blinking frequency using an image processing technique based on the captured eye movements. The processor is configured to integrate analyzed voice data and eye movement data and to determine, using a machine learning technique, presence or absence of alcohol consumption of the driver and a degree of influence of the alcohol consumption. In addition, the processor is configured to use a prompt to instruct a generative artificial intelligence model to evaluate an emotional state of the driver, to analyze the emotional state, and to adjust the degree of influence of the alcohol consumption based on the evaluated emotional state so that emotion-induced variations are distinguished from alcohol-induced variations. Furthermore, the processor is configured to issue a warning to the driver based on a determination result, to request confirmation and consent from a third party when necessary, and to activate a safety mechanism in which an engine does not start by the driver alone when the driver is determined to be under the influence of alcohol. By these means, the system accurately detects alcohol influence using multimodal data analysis, compensates for emotional state, and reliably enforces driving safety through controlled engine start and optional third-party involvement.

The term “processor” refers to a hardware or virtual computing element, such as a central processing unit, microcontroller, system-on-chip, or equivalent programmable circuitry, that executes instructions to perform data acquisition, analysis, control, and communication operations described in the system.

The term “voice data” refers to digital data representing acoustic signals of speech uttered by the driver, obtained by a microphone or equivalent audio input device, and including waveform, spectral, temporal, and prosodic information usable for analysis.

The term “generative artificial intelligence model” refers to a machine learning model, such as a large language model, multimodal model, or other generative model, that is capable of producing or transforming content or analysis results in response to an input prompt and that is used to analyze driver-related data in the system.

The term “prompt” refers to input data, including text, tokens, or structured instructions, provided to a generative artificial intelligence model to specify a requested analysis, evaluation, or operation to be performed on driver-related data.

The term “reaction speed” refers to a temporal characteristic of the driver's response, including a latency or delay between presentation of a question or stimulus to the driver and initiation or completion of the driver's spoken response.

The term “slurring” refers to an abnormal articulation pattern in the driver's speech, characterized by blurred or imprecise pronunciation of phonemes, elongated or merged syllables, or reduced clarity of consonants and vowels as detectable in the voice data.

The term “voice pattern” refers to a combination of acoustic and linguistic features of the driver's speech, including pitch, intensity, rhythm, prosody, spectral distribution, and temporal structure, which can be analyzed to detect deviations associated with alcohol influence or emotional state.

The term “eye movements” refers to movements of the driver's eyes, including changes in gaze direction, saccades, fixations, and eyelid motions such as blinking, as captured by an imaging device.

The term “gaze movement” refers to changes over time in the direction or fixation point of the driver's line of sight, as derived from image data of the driver's eyes and face.

The term “blinking frequency” refers to a number of eyelid closure events per unit time, or an equivalent measure of blinking rate, calculated based on image data capturing the driver's eyes.

The term “image processing technique” refers to an algorithm or set of algorithms applied to image or video data of the driver, including detection, tracking, segmentation, or feature extraction, used to derive gaze movement, blinking frequency, and other eye-related features.

The term “machine learning technique” refers to a computational method that uses a trained model, such as a neural network, decision tree, ensemble model, or other statistical learning algorithm, to infer or classify the presence and degree of alcohol influence based on input features.

The term “presence or absence of alcohol consumption” refers to a binary or categorical determination indicating whether the driver has consumed alcohol at a level relevant to driving safety, as inferred from analyzed data.

The term “degree of influence of the alcohol consumption” refers to a quantitative or qualitative measure representing the extent to which the driver's ability to drive is affected by alcohol, including multiple levels or scores corresponding to different severities.

The term “emotional state” refers to a psychological or affective condition of the driver, such as stress, anger, fear, fatigue, or calmness, inferred from voice data, facial expressions, or other behavioral indicators.

The term “warning” refers to a notification, message, or alert provided to the driver, by visual, auditory, or haptic means, indicating a detected risk related to alcohol influence and/or associated driving safety concerns.

The term “third party” refers to a person or entity other than the driver, such as a family member, guardian, fleet manager, or authorized supervisor, who is registered or designated to receive notifications and provide confirmation and consent relating to engine start.

The term “confirmation and consent” refers to an explicit approval or rejection provided by a third party in response to a request from the system, indicating whether engine start or vehicle operation by the driver is permitted under the current conditions.

The term “safety mechanism” refers to a hardware, software, or combined control function that restricts or prevents engine start or vehicle operation based on determination results regarding alcohol influence and third-party consent status.

The term “engine does not start by the driver alone” refers to a condition in which, without fulfillment of predetermined criteria such as a non-influenced determination or third-party approval, a start command initiated solely by the driver is not permitted to activate the engine.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

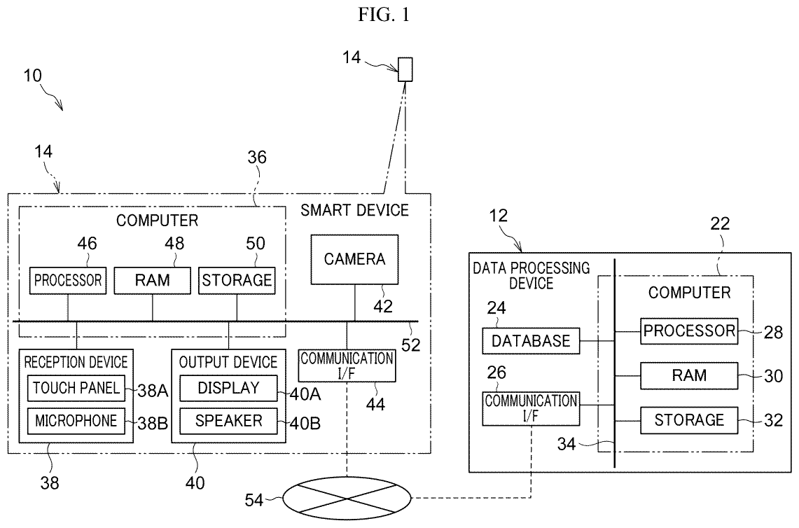

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

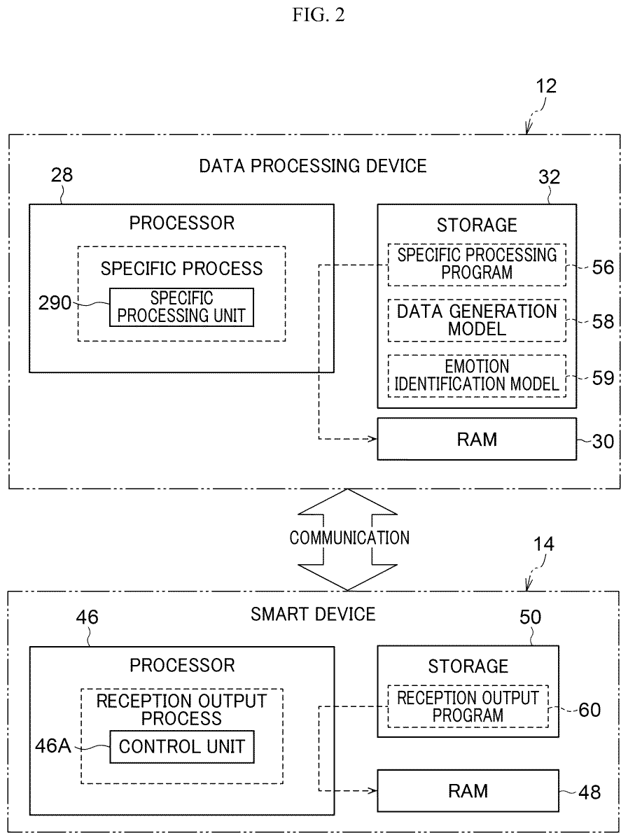

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional driver monitoring systems that attempt to detect intoxication commonly rely on single-modality sensing, such as breath alcohol concentration, simple facial image analysis, or basic voice heuristics. Such systems are often implemented as isolated hardware modules or rule-based software components. They typically do not integrate heterogeneous temporal data streams (for example, speech timing and eye-movement dynamics) at fine-grained time resolution, and they do not make full use of modern machine learning models to infer an intoxication state. As a result, conventional systems suffer from limited robustness, high false-positive and false-negative rates, and poor adaptability across different drivers, environments, and cultural or linguistic contexts.

In addition, when complex models are used, conventional systems usually expose only a binary or scalar output (for example, “safe/unsafe” or a single risk score) generated by a black-box algorithm. They do not provide a structured, human-readable explanation of how particular behavioral features, such as reaction delay, speech slurring, blink rate, or gaze instability, contributed to the decision. This lack of transparency undermines user trust, complicates debugging and regulatory review, and makes it difficult for system operators or third parties to verify whether the system is functioning correctly in edge cases.

Furthermore, existing driver assistance platforms generally do not provide a computationally efficient mechanism to reuse the same internal analysis data both for real-time safety control (for example, engine start inhibition) and for natural-language explanation. When a natural-language interface is bolted on, it is often implemented as a separate application that re-derives or approximates the analysis, which increases latency, resource consumption, and inconsistency between the safety decision and the explanation presented to the user.

From a computer-technology perspective, there is therefore a need for an improved data processing architecture and method that: (i) acquires and aligns multi-modal time-series data (acoustic and visual) in a structured manner; (ii) derives machine-learning-ready feature vectors for intoxication inference with reduced computational overhead and improved accuracy; and (iii) exposes the internal analytic state through a programmatic interface to a generative AI model so that coherent, context-grounded natural-language explanations can be produced without duplicative processing. The technical problem addressed by the invention is to improve the way a computer system represents, synchronizes, and utilizes driver-behavior data so as to enhance the reliability, interpretability, and controllability of intoxication detection and associated safety control.

The specific processing by the specific processing unit 290 of the data processing device 12 in Example 1 is realized by the following means.

The present invention provides a server comprising a processor configured to acquire acoustic information of a driver from an audio input device, execute a speech recognition process to convert the acoustic information into character information and time information, and calculate a reaction time and a speech clarity value based on the character information and the time information; acquire image information including an eye region of the driver from an image acquisition device, perform image processing on the image information to detect the eye region, and calculate a blink frequency and a gaze direction variation amount based on position changes of an eyelid and a pupil; synchronize the reaction time, the speech clarity value, the blink frequency, and the gaze direction variation amount on a common time axis and generate, for each of predetermined time intervals, a feature vector including the reaction time, the speech clarity value, the blink frequency, and the gaze direction variation amount; input the feature vector into a machine learning model and output, from the machine learning model, a determination result regarding a presence or absence of intoxication of the driver and a degree of influence of the intoxication; format evaluation information including the determination result and the feature vector into a text representation, attach a prompt sentence that instructs a generative AI model to generate an explanation of the evaluation information, transmit the text representation and the prompt sentence to the generative AI model, and obtain, from the generative AI model, an explanatory text regarding a state of the driver; and generate control information indicating whether activation of a power unit of a vehicle is permitted or prohibited in accordance with the determination result, and transmit the control information to a safety mechanism so as to control the safety mechanism such that the power unit is not activated solely by an operation of the driver. This enables the computer system to efficiently integrate multi-modal behavioral measurements into synchronized feature vectors for machine-learning-based intoxication inference, while programmatically coupling those same feature vectors and inference results to a generative AI model through structured prompt sentences, thereby improving the technical performance of intoxication detection, enhancing the consistency between safety control and explanation output, and reducing computational redundancy in generating natural-language explanations.

The term “acoustic information” refers to digital or analog data representing sound produced by a driver, including speech signals and non-speech vocalizations, which are obtained from an audio input device for subsequent processing by a computing system.

The term “audio input device” refers to an apparatus that converts sound waves into electrical or digital signals, such as a microphone or an in-vehicle audio sensor, which is configured to capture sound in the vicinity of a driver.

The term “speech recognition process” refers to a computational procedure that converts acoustic information into symbolic representations, including character information and associated time information, by applying pattern recognition, statistical modeling, or machine learning to the acoustic information.

The term “character information” refers to textual data obtained by the speech recognition process, including characters, words, or phonetic symbols that represent the linguistic content of the driver's speech.

The term “time information” refers to temporal data associated with the character information, including timestamps or time intervals indicating when particular units of speech, such as words or phonemes, start and end within the acoustic information.

The term “reaction time” refers to a time duration calculated based on the time information, indicating a delay between a predefined stimulus or prompt and a corresponding speech response of the driver.

The term “speech clarity value” refers to a numerical indicator derived from the character information and the time information, representing an estimated degree of articulation or slurring in the driver's speech.

The term “image information” refers to digital data representing one or more images or frames, including still images and video frames, that contain a depiction of at least a part of a driver, such as a face or an eye region.

The term “image acquisition device” refers to an apparatus that captures optical information and converts it into image information, such as a camera or an imaging sensor installed in a vehicle or in a terminal device.

The term “eye region” refers to a portion of the image information that contains at least an eyelid and a pupil of the driver, as determined by an image processing procedure.

The term “image processing” refers to computational operations applied to image information, including detection, segmentation, tracking, and measurement of visual features, for the purpose of extracting information about the driver's eyes or other body parts.

The term “blink frequency” refers to a number of blink events per unit time, calculated based on changes in an eyelid position in the eye region over a time period.

The term “gaze direction variation amount” refers to a numerical indicator of temporal fluctuation in an estimated gaze direction of the driver, derived from positional changes of a pupil or related eye features across multiple frames of the image information.

The term “feature vector” refers to an ordered set of numerical values, including at least the reaction time, the speech clarity value, the blink frequency, and the gaze direction variation amount, that is generated for each predetermined time interval to serve as input to a machine learning model.

The term “predetermined time interval” refers to a fixed or configurable temporal segment, such as a time window of specified length, over which behavioral measurements of the driver are aggregated and represented as a feature vector.

The term “machine learning model” refers to a computational model that has been trained using example data, and that is configured to accept a feature vector as input and output a prediction or determination result regarding a condition of the driver, such as intoxication.

The term “determination result” refers to output information produced by the machine learning model, indicating at least a presence or absence of intoxication of the driver and a degree of influence of intoxication, and optionally including a confidence score or classification label.

The term “degree of influence of the intoxication” refers to a measure, such as a continuous score or a discrete level, that represents an estimated severity or impact of intoxication on the driver's behavior or driving capability.

The term “evaluation information” refers to structured data that includes at least the determination result and one or more feature vectors, and that is used as a basis for further processing, such as explanation generation or control decision making.

The term “text representation” refers to a textual format of the evaluation information, including a structured or unstructured sequence of characters or tokens, that is suitable for use as input context to a generative AI model.

The term “prompt sentence” refers to a natural-language or structured text instruction that is provided together with the text representation to the generative AI model, and that specifies a requested operation, such as generating an explanation of the evaluation information.

The term “generative AI model” refers to a data-driven computational model, such as a language model, trained to produce text output based on input context and a prompt sentence, and configured to generate an explanatory text regarding a state of the driver.

The term “explanatory text” refers to a natural-language output generated by the generative AI model, which describes or interprets the evaluation information, the determination result, or contributing factors related to the driver's state.

The term “control information” refers to data generated by the processor that indicates whether activation of a power unit of a vehicle is permitted or prohibited, or that otherwise encodes a control decision for a safety mechanism.

The term “power unit” refers to a functional assembly that provides mechanical power for moving a vehicle, such as an internal combustion engine, an electric motor, or a hybrid drive system.

The term “safety mechanism” refers to a control system, including hardware and software components, that is configured to receive the control information and to permit or inhibit activation of the power unit in accordance with the control information.

In one embodiment, a server, a terminal, and a safety mechanism cooperate to implement the invention.

The server includes at least one processor, a memory device, a non-volatile storage device, and a communication interface. The server is connected via a network to the terminal and to a vehicle-side gateway that interfaces with a safety mechanism and a power unit. The terminal includes a processor, a memory, a microphone as an audio input device, and a camera as an image acquisition device. The safety mechanism includes a control unit connected to an engine or another type of power unit of a vehicle, and a communication interface configured to receive control information from the server via the vehicle-side gateway.

The terminal executes an application that runs on an operating system such as a mobile operating system or an embedded operating system. The terminal uses a hardware audio driver to convert analog speech signals from the microphone into digital audio samples, and uses a camera driver to capture image frames that include a face and an eye region of a driver. The terminal compresses the audio using a codec such as an adaptive audio codec and compresses video using a codec such as a standardized video codec, and transmits the compressed streams to the server over a secure communication protocol such as HTTPS or an equivalent transport.

The server stores executable program modules in the non-volatile storage device. The program modules include at least: a speech processing module, an image processing module, a feature generation module, a machine learning inference module, a generative AI interface module, a data management module, and a safety control module. The memory device holds intermediate data structures, feature vectors, and model parameters during processing.

The server executes the speech processing module to receive audio streams from the terminal and to perform speech recognition. The server, in one embodiment, uses a speech recognition engine implemented as a deep neural network, such as a sequence-to-sequence acoustic-language model. The server converts audio samples into feature frames, such as Mel-frequency cepstral coefficients or log-Mel filter bank energies, and passes these frames into the acoustic-language model. The server receives, as output, character information in the form of recognized text tokens, and time information including start and end timestamps for each token or subword unit.

The server uses the character information and the time information to compute reaction time and a speech clarity value. The server stores stimulus timestamps corresponding to predetermined prompts or system questions, and the server subtracts those timestamps from response onset timestamps to obtain reaction time values. The server calculates the speech clarity value by computing measures such as average phoneme duration, variance of phoneme duration, and ratio of low-confidence tokens to total tokens. The server represents these values as numeric fields in a structured record, such as a data object containing fields for reaction_time_ms, speech_clarity_score, and transcription_string.

The server executes the image processing module to analyze image frames received from the terminal. The server uses a computer vision library such as a generic image processing library to decode compressed video into individual frames. The server performs face detection using a convolutional neural network trained on facial images, and the server performs facial landmark detection to locate key points such as eye corners and eyelids. The server defines an eye region based on these landmarks and tracks the region across frames.

The server calculates a blink frequency by computing an eye aspect ratio from the landmarks and detecting rapid decreases and increases in the ratio that correspond to eyelid closure and opening. The server counts blink events during a specified time window and divides the count by window length to obtain blink frequency. The server computes a gaze direction variation amount by estimating gaze vectors from pupil centers relative to eye corners and by calculating, over a time window, the variance or standard deviation of the gaze vectors. The server stores these metrics as fields such as blink_rate_per_minute and gaze_variation_metric in another structured record.

The server executes the feature generation module to synchronize speech-based and image-based metrics on a common time axis. The server divides time into predetermined time intervals, for example segments of several seconds. The server assigns each speech-derived measurement and each eye-movement-derived measurement to one or more intervals based on timestamps. The server aggregates values within each interval using statistical operations such as averaging or median computation. The server then constructs a feature vector as an ordered array of numeric values including at least reaction_time_ms, speech_clarity_score, blink_rate_per_minute, gaze_variation_metric, and optionally additional context values such as ambient noise level, frame quality score, or time of day.

The server uses fixed data structures to represent the feature vectors; for example, the server uses a contiguous array in memory where each index corresponds to a predefined feature dimension. This explicit indexing avoids the overhead of dynamic feature lookup and improves cache locality when the server performs batch inference. By pre-aggregating data in these feature vectors, the system reduces the amount of raw data that must be repeatedly scanned, thereby reducing memory bandwidth usage and improving processing speed compared with systems that repeatedly process raw audio and video streams.

The server executes the machine learning inference module to evaluate each feature vector. In one embodiment, the server uses a feed-forward neural network having an input layer corresponding to the number of feature dimensions, multiple hidden layers with non-linear activation functions such as rectified linear units, and an output layer providing a probability of intoxication and a continuous intoxication influence score. The server stores trained weight matrices and bias vectors in the non-volatile storage device and loads them into memory at runtime.

The server computes a forward pass of the neural network by performing matrix multiplication and non-linear activation for each layer. The server uses a loss function such as binary cross-entropy during training and uses gradient-based optimization such as stochastic gradient descent with momentum or adaptive optimization to update the weights. The server, in deployment, uses only the inference part without weight updates, and outputs a determination result including a binary label indicating presence or absence of intoxication and a scalar degree of influence of intoxication.

The server, in some embodiments, implements alternative machine learning models such as gradient boosting decision trees, random forests, or recurrent neural networks. The server selects a particular model type based on the available computational resources and the amount of training data. For each model type, the server uses a consistent feature vector representation, thereby allowing modular replacement of models without redesigning the data acquisition process.

The server executes the generative AI interface module to generate explanations. The server first formats evaluation information, including the determination result and one or more feature vectors, into a text representation. For example, the server generates a human-readable context string describing the latest reaction time, the speech clarity score, the blink rate, the gaze variation, and the intoxication score. The server then constructs a prompt sentence in natural language that instructs a generative AI model to generate an explanation based on this context.

The user may provide additional instructions through the terminal. The user operates a user interface on the terminal and enters a prompt sentence into a text input area. The user may, for example, input the prompt sentence:
“Please tell me the degree of the driver's intoxication based on the latest analysis.”

The user may further input the prompt sentence:
“Explain in detail how the driver's reaction speed, speech slurring, and blink frequency contributed to the intoxication judgment.”

The user may also input the prompt sentence:
“Compare the current driver's condition with the result from 30 minutes ago and describe any improvement or deterioration.”

The server combines the user-provided prompt sentence with the internally generated context string. The server transmits both to a generative AI model hosted either on the same server or on an external computing platform. The server uses a large-scale language model as the generative AI model, for example a transformer-based neural network that has been pre-trained on text and optionally fine-tuned on explanation tasks.

The server specifies, in the request to the generative AI model, parameters such as maximum output length, temperature, and preferred language. The server receives the explanatory text produced by the generative AI model. The server then stores the explanatory text in association with the corresponding evaluation information, and the server provides the explanatory text to the terminal for display.

This architecture provides a technical improvement over conventional systems because the server reuses the same feature vectors for both safety-critical inference and natural-language explanation. The feature generation module and the data structures are designed such that the server does not need to recompute behavioral metrics when an explanation is requested. As a result, the server reduces computational redundancy and network load, thereby accelerating response time and lowering resource usage.

The server executes the safety control module to control the power unit of the vehicle. The server uses the determination result to generate control information indicating whether activation of the power unit is permitted or prohibited. The server sends this control information through the communication interface to the vehicle-side gateway, which relays the command to the safety mechanism. The safety mechanism uses this control information to allow or block activation of the power unit. Because the safety mechanism depends on the determination result computed from synchronized acoustic and visual data, the system ties higher-level analytic processing directly to hardware control, thereby demonstrating a concrete application in the physical world.

The server may also use emotion-related feature values derived from both audio and image data. For example, the server computes prosodic features such as pitch contour variation and energy distribution from the acoustic information, and the server computes facial expression features using an additional neural network trained for emotion classification. The server then generates a prompt sentence for the generative AI model requesting an evaluation of the driver's emotional state based on these features. The server uses the resulting emotion state evaluation to correct or adjust the intoxication influence score, for instance decreasing the score when stress-related signs explain certain anomalies, or increasing the score when emotion and physical indicators both support intoxication.

This combined use of a discriminative machine learning model and a generative AI model is implemented using explicit protocols and data structures. The server constructs structured messages containing feature vectors and metadata, passes them into the discriminative model, and then constructs contextual text descriptions for the generative AI model. This separation of concerns allows the server to maintain deterministic safety decisions while exploiting a flexible natural-language layer for user-facing explanations, and it improves transparency without requiring duplication of computational pipelines.

The terminal presents to the user both the determination result and the explanatory text. The terminal may display a visual representation such as a color-coded risk indicator, along with the explanation that cites specific metrics (for example, “The driver's reaction time was 850 ms, which is above the normal threshold, and the blink rate was significantly elevated”). The user can read this information and can optionally input additional prompt sentences to request simplified summaries or technical details.

From a computer-technology standpoint, this system enhances processing efficiency and accuracy by aligning multi-modal time-series data into compact, fixed-length feature vectors, which are specifically tailored for machine learning. Unlike a human operator who might subjectively observe speech and eye behavior, the server uses precise numeric thresholds, temporal alignment algorithms, and pre-trained models with learned internal representations.

The server thereby reduces variance due to human subjectivity and increases reproducibility and scalability.

The server achieves further technical advantages by reducing communication load. The terminal transmits only compressed audio and video data in real time, while the server is responsible for heavy-weight analysis. When explanations are generated, the server does not request additional raw data but uses feature vectors and stored evaluation information. This design limits repeated transmissions over the network and improves performance in bandwidth-constrained environments.

In other embodiments, the server may be distributed across multiple physical machines. One machine may handle speech recognition and audio feature extraction, another may handle image processing and gaze estimation, and a third may perform machine learning inference and generative AI communication. The server instances exchange intermediate representations over a local data bus or a high-speed data network. This distributed design allows the system to scale to many terminals without overloading a single processor, and it separates latency-critical computations from explanation-oriented computations.

In another embodiment, the terminal performs some portion of the processing locally. For example, the terminal may run a lightweight neural network for eye detection and may transmit only eye landmark coordinates to the server, rather than full video frames. This reduces network bandwidth usage and offloads part of the processing from the server. The server adjusts the feature generation module accordingly to accept either raw image data or preprocessed feature data, and the server still constructs feature vectors in a consistent format.

In still another embodiment, the safety mechanism may be integrated with additional vehicle subsystems. The server may send graded control information, such as commands to limit maximum speed, to restrict acceleration, or to require periodic re-evaluation, instead of only allowing or preventing activation. The server uses the same determination results and feature vectors but interprets the intoxication influence score under different rule sets depending on regulatory requirements or operational policies.

The system as a whole therefore extends beyond simple automation of a human judgment task. The server defines specific feature extraction algorithms, synchronization procedures, neural network architectures, and communication patterns that are not readily performed by a human. These algorithms exploit the ability of a computer to process high-dimensional, high-frequency data streams, to apply trained parameters computed from large datasets, and to coordinate decisions with vehicle hardware. Consequently, the invention improves computer technology by providing more accurate and faster intoxication assessment, better utilization of computational resources, and a structured interface between analytic models and generative AI models for explainability, all of which are tightly integrated with control of real-world machinery.

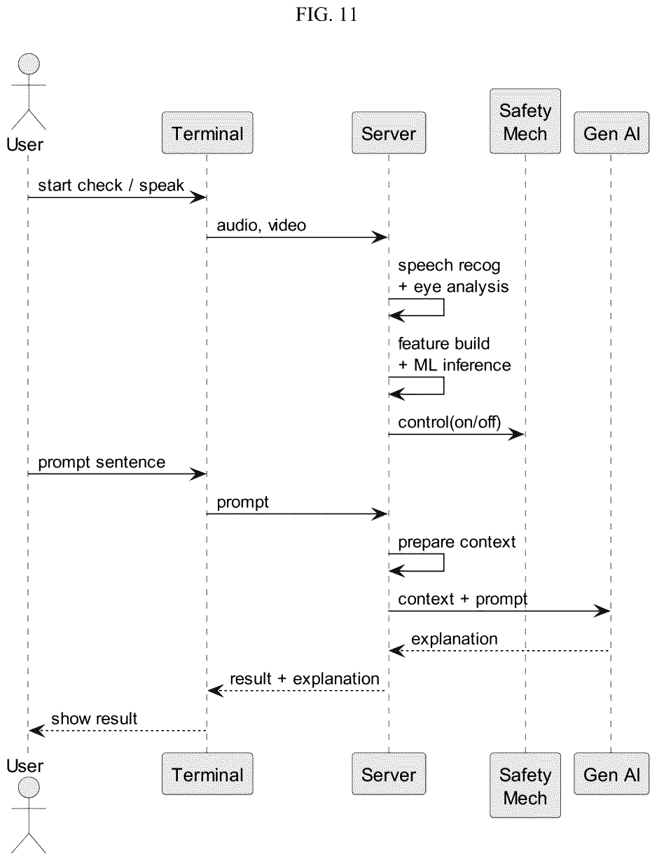

The following describes the processing flow using FIG. 11.

### Step 1:

The terminal activates an audio input device and captures driver speech.

The terminal receives, as input, analog sound waves produced by the driver and converts the sound waves into digital audio samples using an audio codec.

The terminal performs data processing by sampling the analog signal at a predetermined sampling rate, quantizing the samples into numerical values, framing the samples into short time windows, and encoding the frames using an audio compression algorithm.

The terminal outputs a compressed audio stream containing time-stamped frames that represent the driver's speech.

### Step 2:

The terminal activates an image acquisition device and captures driver face and eye images.

The terminal receives, as input, optical information from a camera that is directed toward the driver and converts the optical information into digital image frames.

The terminal performs data processing by setting camera parameters such as resolution and frame rate, encoding the frames into a compressed video sequence, and attaching timestamps to each frame or group of frames.

The terminal outputs a compressed video stream containing sequential frames in which a face region and an eye region of the driver are visible.

### Step 3:

The terminal transmits audio and video data to the server over a network.

The terminal receives, as input, the compressed audio stream and the compressed video stream previously generated.

The terminal performs data processing by packaging audio and video data into network messages, adding metadata such as driver identifiers and timestamps, and applying a secure communication protocol.

The terminal outputs network packets that deliver the compressed audio and video streams to the server.

### Step 4:

The server receives and stores raw sensing data from the terminal.

The server receives, as input, the network packets containing the compressed audio and video streams.

The server performs data processing by decoding the network protocol, extracting the payloads, buffering the streams in memory, and writing them to temporary storage with associated metadata.

The server outputs stored audio files or streams and stored video files or streams, each linked to session information and driver identifiers.

### Step 5:

The server executes speech recognition on the audio data to obtain character and time information.

The server receives, as input, the stored audio data representing the driver's speech.

The server performs data processing by segmenting the audio into frames, computing acoustic features such as Mel-frequency cepstral coefficients, and feeding the features into a speech recognition engine implemented as a trained neural network or statistical model.

The server outputs character information (recognized text tokens) and time information (start and end timestamps for each token or phoneme) for the entire utterance.

### Step 6:

The server computes reaction time and a speech clarity value from the recognition result.

The server receives, as input, the character information and time information from the speech recognition process, together with reference timestamps corresponding to known prompts or stimuli.

The server performs data processing by subtracting prompt timestamps from response onset timestamps to calculate reaction time values, and by analyzing token-level confidence scores, phoneme durations, and substitution or deletion patterns to compute a numeric speech clarity value.

The server outputs structured speech analysis data containing at least a reaction time field, a speech clarity field, and a transcript field.

### Step 7:

The server decodes and preprocesses video frames for eye analysis.

The server receives, as input, the stored compressed video stream that includes the driver's face and eyes.

The server performs data processing by decoding the compressed video into individual frames using a video decoding library, normalizing frame sizes, and optionally applying noise reduction or contrast enhancement to improve visibility of eye features.

The server outputs a sequence of preprocessed image frames with timestamps and associated session identifiers.

### Step 8:

The server detects the face and eye regions in each frame.

The server receives, as input, the preprocessed image frames.

The server performs data processing by applying a face detection model to locate bounding boxes of the driver's face and then applying a facial landmark detection model to estimate positions of facial keypoints, including eye corners and eyelids.

The server outputs, for each frame, coordinates of face bounding boxes and coordinates of eye region landmarks, stored as numerical arrays.

### Step 9:

The server calculates blink frequency and gaze direction variation from eye landmarks.

The server receives, as input, the eye region landmark coordinates for a sequence of frames.

The server performs data processing by computing an eye aspect ratio from eyelid landmarks to detect closure events, counting these events over a time interval to obtain blink frequency, and estimating gaze direction vectors from relative positions of the pupil centers within the eye region across frames to compute a gaze direction variation amount.

The server outputs structured eye-movement analysis data including fields for blink frequency and gaze direction variation, with timestamps indicating the time window used.

### Step 10:

The server synchronizes speech-based and eye-based metrics on a common time axis.

The server receives, as input, the speech analysis data (reaction time and speech clarity) and the eye-movement analysis data (blink frequency and gaze variation), along with their respective timestamps.

The server performs data processing by defining predetermined time intervals, assigning each measurement to an interval based on its timestamp, and applying aggregation functions such as mean, maximum, or minimum to obtain one consolidated value per metric for each interval.

The server outputs synchronized metric records where each record corresponds to one time interval and includes aggregated reaction time, speech clarity, blink frequency, and gaze variation values.

### Step 11:

The server generates feature vectors for machine learning inference.

The server receives, as input, the synchronized metric records for each time interval.

The server performs data processing by mapping each metric to a predefined position within an ordered array, scaling the metric values using stored normalization parameters (for example, subtracting a mean and dividing by a standard deviation), and concatenating the scaled values into a fixed-length feature vector.

The server outputs feature vectors suitable for input to a machine learning model, each feature vector representing behavioral characteristics of the driver for a specific time interval.

### Step 12:

The server executes a machine learning model to infer intoxication.

The server receives, as input, the feature vectors generated in the previous step.

The server performs data processing by passing each feature vector through a trained model, such as a multi-layer neural network or a boosted decision tree ensemble, computing intermediate layer activations or decision tree outputs, and applying a final activation or aggregation function to produce probability scores and influence levels.

The server outputs, for each feature vector, a determination result including at least a binary intoxication label and a continuous intoxication influence score.

### Step 13:

The server aggregates determination results and generates a final intoxication assessment.

The server receives, as input, multiple determination results corresponding to multiple time intervals.

The server performs data processing by combining these results using rules such as majority voting, weighted averaging of influence scores, or temporal smoothing to reduce transient fluctuations, and by applying threshold values to decide an overall intoxication state.

The server outputs a final intoxication assessment that includes an overall label, an aggregated influence score, and confidence information.

### Step 14:

The server constructs evaluation information for explanation and logging.

The server receives, as input, the final intoxication assessment and the underlying feature vectors or metric records.

The server performs data processing by organizing these data into a structured representation that associates each component of the assessment with the corresponding metrics (for example, linking a high influence score to elevated reaction time and blink rate), and converting this structure into a text representation that can be interpreted by a language model.

The server outputs evaluation information in text form that describes the metrics, their values, and their contribution to the final decision.

### Step 15:

The user inputs a prompt sentence requesting an explanation.

The user receives, as input, a user interface presented on the terminal that shows the current status or a field for text entry.

The user performs an action by typing a natural-language request into the input field, such as “Please tell me the degree of the driver's intoxication based on the latest analysis,” and by submitting the request via a user interface control.

The terminal outputs the user's prompt sentence to the server as part of a request message.

### Step 16:

The server combines the evaluation information with the user's prompt sentence for the generative AI model.

The server receives, as input, the text-formatted evaluation information and the user's prompt sentence.

The server performs data processing by concatenating or otherwise integrating the evaluation information with the prompt sentence into a single context input, arranging sections that describe metrics and results before or after the user's instruction, and formatting the combined text in accordance with the generative AI model's interface specification.

The server outputs a combined textual input that includes both the evaluation information and the user's prompt sentence.

### Step 17:

The server requests an explanatory text from a generative AI model.

The server receives, as input, the combined textual input prepared for the generative AI model.

The server performs data processing by sending the combined text to an inference endpoint for a large-scale language model, specifying parameters such as maximum token length, output temperature, and target language, and by waiting for the model to generate text conditioned on the input.

The server outputs an explanatory text that describes the driver's state, the intoxication level, and contributing factors in natural language.

### Step 18:

The server logs and returns the explanatory text to the terminal.

The server receives, as input, the explanatory text from the generative AI model.

The server performs data processing by associating the explanatory text with the corresponding intoxication assessment and feature vectors in persistent storage, and by formatting the explanatory text with additional metadata such as timestamps or session identifiers for display.

The server outputs a response message containing the explanatory text and related metadata to the terminal.

### Step 19:

The terminal presents the determination result and explanatory text to the user.

The terminal receives, as input, the response message from the server containing the final assessment and the explanatory text.

The terminal performs data processing by parsing the message, updating on-screen elements to show indicators such as “safe” or “unsafe,” and rendering the explanatory text in a readable layout.

The terminal outputs a visual display that allows the user to read the intoxication assessment and understand how the underlying metrics influenced the decision.

### Step 20:

The server generates and sends control information to the safety mechanism.

The server receives, as input, the final intoxication assessment and associated influence score.

The server performs data processing by comparing the influence score to predefined thresholds, selecting a control state such as “allow engine start” or “prohibit engine start,” and encoding this state into control information structured for the vehicle-side communication protocol.

The server outputs a control message that instructs the safety mechanism to either permit or block activation of the power unit based on the intoxication assessment.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Human-machine interfaces in vehicles increasingly rely on software-based monitoring of drivers, including speech analysis and image analysis, to detect impaired driving conditions such as alcohol influence. Conventional systems, however, suffer from several technical limitations that reduce accuracy, robustness, and adaptability.

First, conventional systems typically process acoustic information and image information in a loosely coupled or sequential manner, without precise synchronization of timing information.

For example, systems may analyze speech content independently of the timing of queries presented to the driver, or may evaluate eye images without correlating them with specific conversational segments. This lack of integrated, time-aligned processing leads to inaccurate estimation of reaction time, speech clarity, and attention state, and can cause false positives or false negatives in detecting alcohol-related impairment.

Second, conventional systems often rely on static threshold values or handcrafted rules for classifying driver states based on audio and video features. These fixed parameters do not adapt well to inter-individual differences, such as a driver's natural speaking style, baseline reaction speed, or normal blink frequency. As a result, such systems cannot maintain high detection performance across diverse drivers, environments, and longitudinal changes in behavior, and they frequently generate unreliable risk assessments.

Third, many existing driver-monitoring solutions do not exploit modern generative information processing models to refine algorithms and thresholds over time. In typical implementations, once a machine learning classifier or rule set is deployed, it is rarely updated using higher-level reasoning or meta-optimization. This limits the system's ability to incorporate new multimodal features, adjust decision logic, or optimize warning strategies and safety mechanisms in response to real-world operational data.

Fourth, conventional systems handle emotional state, if at all, as an optional overlay that is not technically integrated into the core risk computation. Emotional conditions such as stress, fatigue, or anxiety can affect speech patterns and eye movements in ways that mimic alcohol influence, but existing systems often fail to model and compensate for these confounding factors. Consequently, these systems cannot reliably distinguish between alcohol-induced impairment and non-alcohol-related emotional changes, which degrades overall system performance.

Fifth, safety actions such as vehicle speed limitation, automatic stopping, or engine start prohibition are often triggered based solely on a single detection result, without multi-level escalation logic, third-party verification, or feedback into the underlying models. The absence of graded warning levels, confirmation workflows, and learning from the outcomes of such interventions leads to suboptimal control strategies and diminished user trust.

Accordingly, there is a need for an improved computer-implemented driver monitoring system that (i) tightly integrates time-aligned multimodal analysis of acoustic and image information, (ii) dynamically learns and corrects risk indices per driver, (iii) leverages generative information processing models via structured prompt sentences to design and update estimation algorithms and thresholds, (iv) incorporates emotional state estimation into the risk computation, and (v) optimizes multi-level warning and safety control logic based on historical data and higher-level model feedback. Such a system constitutes a concrete improvement in computer technology by enhancing how processors acquire, structure, analyze, and adapt multimodal sensor data to produce more accurate and reliable driver risk assessments and control actions.

The specific processing by the specific processing unit 290 of the data processing device 12 in Application Example 1 is realized by the following means.

The present invention provides a server comprising a processor configured to acquire acoustic and image information from a terminal device, segment the acoustic information based on time information, compute a response reaction time of a driver from differences between segment start timings and query transmission timings, perform speech recognition to convert the acoustic information into character information, extract multiple acoustic feature quantities from the character information and the acoustic information, analyze the image information to detect a face region and an eye region and derive eye-related feature quantities, compute indices including at least an attention state index and an eye-movement abnormality index, normalize and integrate the reaction time and the indices using a machine learning algorithm to calculate a risk index indicating presence or absence of alcohol consumption and a degree of influence on driving ability, record the feature quantities and the risk index in association with time-series information and dynamically correct at least one of the risk index and a reference value per driver, generate structured prompt sentences for a generative information processing model to design or update estimation algorithms and reference values, and control generation and output of warnings and safety actions based on the calculated risk index. This enables a technically improved, computer-implemented driver monitoring architecture that performs fine-grained, time-aligned multimodal fusion, adapts classification behavior to individual drivers and evolving conditions, and uses generative model feedback to continuously optimize both the underlying machine learning algorithms and the safety control strategies, thereby enhancing the accuracy, robustness, and reliability of alcohol-related impairment detection and corresponding vehicle control.

The term “acoustic information” refers to time-series data representing sound captured from a driver, including, for example, voice waveforms, background noise, and any other audio signals that can be digitized and processed by the system.

The term “image information” refers to visual data captured from a driver, including, for example, still images or video frames representing the driver's face, eyes, and surrounding environment, which can be digitized and processed by the system.

The term “terminal device” refers to an electronic apparatus installed in or associated with a moving body, the apparatus being configured to capture acoustic information and image information of a driver and to transmit the captured information to a server or processor.

The term “moving body” refers to any vehicle or transport apparatus capable of movement, including, for example, automobiles, trucks, buses, or other powered transportation devices.

The term “reaction time” refers to a time interval calculated as a difference between a timing at which a query or prompt is transmitted from a processor to a terminal device and a timing at which an acoustic response from a driver is detected based on the acoustic information.

The term “query information” refers to information generated by a processor and transmitted to a terminal device to prompt a driver to provide a spoken or behavioral response, the information including at least one question, instruction, or command.

The term “speech recognition processing” refers to a computational technique for converting acoustic information representing spoken language into machine-readable character information, typically text, using an automatic speech recognition algorithm.

The term “character information” refers to symbol data, such as text or alphanumeric strings, generated by converting acoustic information representing speech into a written representation.

The term “acoustic feature quantities” refers to numerical values derived from acoustic information and/or character information, the numerical values including, for example, utterance speed, pause duration, repetition of words, frequency of self-corrections, volume fluctuation, fundamental frequency, and spectral feature quantities.

The term “utterance speed” refers to a measure of how quickly a driver speaks over time, such as the number of words, syllables, or phonetic units produced per unit of time.

The term “pause duration” refers to a time length of intervals within acoustic information during which no speech or substantially no speech is detected between spoken segments.

The term “repetition of words” refers to an occurrence pattern in which the same word or phrase is spoken multiple times by a driver within a given time window or utterance segment.

The term “frequency of self-corrections” refers to a count or rate at which a driver interrupts or modifies their own speech to correct previously spoken words or phrases within an utterance.

The term “volume fluctuation” refers to a variation in sound intensity or loudness in acoustic information over time, typically measured as changes in signal amplitude or energy.

The term “fundamental frequency” refers to a lowest frequency component of a periodic voice signal corresponding to perceived pitch, as derived from acoustic information of a driver's speech.

The term “spectral feature quantities” refers to values obtained from a frequency-domain representation of acoustic information, including, for example, spectral centroid, spectral flux, formant frequencies, and other frequency-based descriptors.

The term “clarity of utterance” refers to a quality measure of how intelligible and well-articulated a driver's speech is, as evaluated based on one or more acoustic feature quantities and optionally on character information.

The term “utterance pattern” refers to a combination of temporal and acoustic characteristics of a driver's speech, including, for example, rhythm, intonation, prosody, and consistency of articulation over time.

The term “face region” refers to a portion of image information corresponding to a driver's face, identified using a face detection algorithm.

The term “eye region” refers to one or more localized portions of image information within a detected face region corresponding to a driver's eyes and surrounding eyelid areas.

The term “blink count” refers to a number of instances in which the eye region transitions from an open state to a closed state and back to an open state within a predetermined time period.

The term “blink duration” refers to a length of time for which an eye remains in a closed or partially closed state during a blink event.

The term “eyelid opening degree” refers to a measure of how wide a driver's eyelids are open, typically quantified as a ratio or distance between upper and lower eyelids relative to a reference.

The term “gaze direction” refers to an estimated orientation of a driver's line of sight, determined based on positions of pupils, eye regions, and other facial landmarks in image information.

The term “variation of gaze direction” refers to changes in the gaze direction over time, quantified, for example, as an amount or frequency of deviation from a reference direction such as a forward-looking direction.

The term “attention state index” refers to a numerical indicator representing a level of attention or concentration of a driver, computed based on eye-related feature quantities, gaze behavior, and optionally additional context.

The term “eye-movement abnormality index” refers to a numerical indicator representing a degree of abnormality in a driver's eye movements, including blink patterns, gaze shifts, and eyelid behavior, relative to expected normal behavior.

The term “machine learning algorithm” refers to a computational model or procedure that learns patterns or relationships from training data and is configured to produce an output, such as a classification or regression result, from input feature quantities without explicit rule-based programming.

The term “risk index” refers to a numerical or categorical value indicating presence or absence of alcohol consumption by a driver and/or a degree of influence of the alcohol consumption on a driving ability of the driver.

The term “reference value” refers to a threshold or baseline parameter used for comparing with the risk index or other indices to determine whether to generate a warning, to adjust a model, or to initiate a safety action.

The term “time-series information” refers to information that associates data with corresponding time points or time intervals, enabling chronological ordering and temporal analysis of feature quantities and indices.

The term “dynamic correction” refers to an adjustment process in which at least one of the risk index or the reference value is modified over time based on accumulated historical data, driver-specific baselines, or updated estimation results.

The term “generative information processing model” refers to a computational model configured to generate information, such as algorithms, parameter sets, or explanatory text, in response to structured input, including, for example, a large-scale probabilistic model or a neural network used for text generation or design assistance.

The term “prompt sentence” refers to a structured text or data input provided to a generative information processing model, the text or data specifying a task, constraint, or objective for designing, updating, or optimizing an algorithm, parameter, or control strategy.

The term “estimation algorithm” refers to a computational procedure configured to compute an index, such as the risk index or an emotional state index, from one or more feature quantities derived from acoustic information, image information, or other data.

The term “warning information” refers to information generated by a processor to notify a driver or a third party of a potential risk condition, including, for example, messages, alerts, or indicators to be output visually, audibly, or through haptic feedback.

The term “safety mechanism” refers to a control system or function in a moving body configured to modify operation of the moving body in response to a risk condition, including, for example, engine start prohibition, power output limitation, and automatic vehicle stopping.

The term “emotional state index” refers to a numerical or categorical indicator representing an estimated emotional condition of a driver, such as stress, fatigue, or excitement, computed from one or more feature quantities extracted from acoustic information and image information.

The term “vocabulary pattern” refers to a characteristic distribution or sequence of words or word types used by a driver over a period of time, which can be analyzed to infer emotional or cognitive states.

The term “facial expression” refers to a visual configuration of a driver's facial muscles, including positions of eyebrows, eyes, mouth, and other features, detected and interpreted from image information to infer affective or emotional states.

The term “warning level” refers to a classification of severity or urgency associated with a detected risk state, used to determine what type of warning information or safety mechanism should be activated.

The term “third-party terminal device” refers to an electronic apparatus operated by a person other than the driver, such as a guardian, supervisor, or monitoring operator, which can receive notifications, provide consent information, or interact with the system regarding safety actions.

The term “power generation device” refers to an energy source or engine of a moving body responsible for providing propulsion, including, for example, an internal combustion engine, an electric motor, or a hybrid power unit.

The term “automatic stopping” refers to a control action in which a moving body is autonomously brought to a halt by a control system without requiring direct manual intervention by the driver, typically in a safe and controlled manner.

In one embodiment, the server, the terminal, and the user cooperate to implement a driver monitoring system that analyzes multimodal data to estimate alcohol-related impairment and to control a moving body. The server executes a program stored in a non-transitory computer-readable medium. The server is implemented, for example, as an in-vehicle electronic control unit or as a remote computing apparatus connected over a wireless network. The terminal is implemented, for example, as an in-vehicle human-machine interface device including a microphone, a camera, a display, a loudspeaker, and a communication interface. The user is a driver of the moving body.

The terminal uses a microphone, such as a digital MEMS microphone, to capture acoustic information of the user. The terminal samples audio at a predetermined sampling rate, for example 16 kHz or 48 kHz, and encodes the audio using a codec such as an adaptive transform codec. The terminal uses a camera, such as an RGB camera mounted on a dashboard, to capture image information including at least the face region and the eye region of the user. The terminal compresses video using a video codec such as a block-based motion-compensated codec. The terminal embeds timestamps into both the audio and video streams using a common time base maintained by an internal clock synchronized with the server. This tight timestamping allows the server to perform precise time alignment between acoustic information and image information.

The terminal transmits the compressed, time-stamped acoustic information and image information to the server over a secure communication channel, for example using a transport-layer security protocol. The server receives the data and stores it in a structured data buffer in main memory. The server uses a ring buffer or queue structure for each modality, where each entry contains a pointer to a data block, a start timestamp, an end timestamp, and metadata such as sampling rate, codec information, and a session identifier. By organizing data in these explicit time-indexed structures, the server can efficiently retrieve and process multimodal segments corresponding to the same time intervals, which reduces synchronization errors and improves computational efficiency.

The server generates queries to the user in order to elicit spoken responses suitable for analysis. The server selects a prompt sentence from a repository stored in a database. For example, the server can select one of the following prompt sentences:
“How are you feeling right now? Please answer in one or two sentences.”
“Please say your full name and today's date.”
“Please count from one to ten at your normal speaking speed.”

The server transmits the selected prompt sentence as text or as an identifier of a stored audio file to the terminal. The terminal converts the text into synthesized speech using a text-to-speech engine, or plays back the pre-recorded audio, and outputs the query through the loudspeaker. The user hears the query and responds verbally. The terminal continues capturing acoustic information and image information during the user's response. The server uses the timestamps of the query transmission and the timestamps of the incoming acoustic information to compute a reaction time. The server detects the start of the user's response by applying a voice activity detection algorithm to the acoustic information. In one embodiment, the server uses an energy-based and spectral-based detector that maintains a sliding window over the audio stream and compares short-time energy and spectral entropy to adaptive thresholds. The server registers the first time at which speech is detected after the query and subtracts the query transmission time. The server stores the computed reaction time in a reaction time table indexed by driver identifier, session identifier, query identifier, and timestamp. This explicit computation and storage of reaction time as a structured value improves temporal precision and enables later dynamic normalization across different drivers and conditions.

The server converts segments of acoustic information into character information using a speech recognition system. In one embodiment, the server uses an external speech recognition service, which accepts audio data and returns recognized text with word-level time offsets. The server passes segmented acoustic information corresponding to the user's response, and receives, for each utterance, a sequence of tokens, start times, end times, and confidence scores. The server stores these outputs in a text segment table, where each record includes the recognized text, an array of token timestamps, and a link to the original acoustic segment in the acoustic buffer.

The server computes acoustic feature quantities from both the acoustic information and the character information. The server calculates utterance speed by dividing the number of tokens or syllables by the duration of the utterance segment. The server identifies pauses by locating gaps between tokens exceeding a silence threshold, and computes pause duration statistics such as mean pause length and total silent time per utterance. The server detects repetition of words by searching for identical tokens occurring in close succession, and counts the frequency of such repetitions. The server determines frequency of self-corrections by identifying sequences where low-confidence tokens are followed by content-replacement tokens within a predetermined time window.

At the signal level, the server applies a digital signal processing library to the acoustic information to compute volume fluctuation and fundamental frequency. The server derives a loudness contour by calculating short-time energy or root-mean-square amplitude over overlapping frames, and quantifies volume fluctuation as statistical variance or range of this contour. The server estimates fundamental frequency using a pitch estimation method such as an autocorrelation-based algorithm or a cepstrum-based algorithm. The server further transforms frames of acoustic information into a frequency-domain representation using a fast Fourier transform and extracts spectral feature quantities such as spectral centroid, spectral bandwidth, and spectral flatness. The server aggregates these frame-level features into segment-level descriptors by computing mean, variance, and higher-order moments over the duration of each utterance.

The server evaluates clarity of utterance and utterance pattern based on the acoustic feature quantities. In one embodiment, the server uses a feedforward neural network implemented in a deep learning framework. The server constructs a feature vector for each utterance by concatenating normalized measures such as utterance speed, mean pause duration, repetition count, self-correction count, volume fluctuation, mean fundamental frequency, and spectral statistics. The neural network can have, for example, an input layer receiving the feature vector, two or more hidden layers with rectified linear activation functions, and an output layer producing a continuous score for clarity and a continuous score for regularity of utterance pattern. The server trains this neural network offline using supervised learning. The server uses labeled training data collected from multiple drivers under known conditions, including sober and alcohol-influenced states. During training, the server minimizes a loss function such as mean squared error between predicted clarity scores and ground truth clarity labels. The server updates network weights using gradient descent with backpropagation and an optimizer such as an adaptive moment estimation optimizer. The server optionally performs data augmentation by adding controlled noise, pitch shifting, or time-stretching to the training audio signals to improve robustness.

The server analyzes the image information to derive eye-related features. The server uses an image processing library to perform face detection on each frame, for example by applying a pre-trained cascade classifier or a convolutional neural network-based detector. Once the server identifies a face region, the server applies a facial landmark detection algorithm to locate the eye regions and eyelid contours. The server tracks the eye regions across consecutive frames by associating detected landmarks with temporal smoothing.

The server computes a blink count by detecting transitions between open and closed states of the eyes. The server calculates an eyelid opening degree for each frame as a ratio between vertical distances of eyelid landmarks and a reference facial scale such as interpupillary distance. The server labels frames with eyelid opening degrees below a threshold as closed, and counts a blink event when a sequence transitions from open to closed and back to open.

The server computes blink duration as the time from the first closed frame to the next open frame. The server estimates gaze direction by computing the relative position of pupils within the eye regions. The server can fit an ellipse to the iris region and determine horizontal and vertical offsets relative to the eye contour. The server then computes variation of gaze direction over time as a measure of deviation from a forward-looking reference.

The server aggregates the frame-level features over a defined time window, for example 30 seconds, and computes an attention state index and an eye-movement abnormality index. In one embodiment, the server uses a recurrent neural network or a temporal convolutional network that accepts a sequence of eye-related feature vectors and outputs an attention score.

The server trains this temporal model on labeled sequences of gaze behavior collected under conditions such as focused driving, distracted driving, and impaired driving. The server uses a sequence loss function, such as time-distributed mean squared error or cross-entropy, and updates weights using backpropagation through time. By modeling temporal dependencies, the server can distinguish short, normal blinks from prolonged closures or erratic gaze shifts, thereby improving the sensitivity of the indices.

The server combines the acoustic-derived metrics and the image-derived metrics to compute a risk index. The server constructs a multimodal feature vector that includes the reaction time, the clarity of utterance score, the utterance pattern score, the attention state index, the eye-movement abnormality index, and optionally variance and trends of these values over a past time window. The server normalizes each component using driver-specific baselines stored in a driver profile database. For example, the server stores per-driver mean and standard deviation of reaction time during confirmed sober sessions, and uses these values to compute standardized z-scores. This per-driver normalization reduces the impact of inter-individual differences and results in more consistent risk estimation across the driver population.

The server inputs the normalized multimodal feature vector into a classifier model that outputs the risk index. In one embodiment, the server uses a gradient boosted decision tree model or a multilayer neural network trained to output a continuous risk index in a predefined range. The training data includes labeled examples with known alcohol consumption states and degrees of impairment. The server uses a loss function that penalizes both misclassification of impaired states and overestimation in normal states, for example a weighted mean squared error. The server trains the classifier on a centralized or distributed computing infrastructure and periodically deploys updated model parameters to the in-vehicle server.

The server uses the computed risk index to control warnings and safety actions. When the risk index exceeds a first threshold, the server generates warning information and transmits control information to the terminal instructing it to display a visual alert and output an audible warning, such as “There is a possibility of drinking. Please stop the vehicle safely.”

When the risk index exceeds a higher threshold, the server transmits control information to a moving body control device. The moving body control device reduces power output to the propulsion system, limits acceleration, and initiates a controlled deceleration to bring the vehicle to a stop at a safe location. The moving body control device may also inhibit subsequent engine start until a lower risk index is confirmed. Because these actions are triggered by a quantitatively computed index derived from time-aligned multimodal data, the system achieves a technical effect of reducing the probability of unsafe driving conditions.

The server records feature quantities and risk indices in a time-series database. Each record includes a timestamp, driver identifier, session identifier, acoustic features, image features, computed indices, and control actions taken. The server analyzes historical data to update driver-specific baselines. The server applies incremental learning algorithms or periodic batch training to refine model parameters. By using explicit data structures and update rules, the server manages large volumes of streaming data efficiently, improving memory usage and access latency.

The server further employs a generative information processing model to assist in designing and updating estimation algorithms and thresholds. The server generates prompt sentences that describe current model behavior, observed error patterns, and desired improvements. For example, the server can generate a prompt sentence such as:

“Design an improved algorithm to integrate driver reaction time, speech clarity score, voice pattern features, blink frequency, blink duration, and gaze direction variance into a single risk index for alcohol-related impairment detection. The current model uses normalized z-scores and a three-layer neural network but tends to underestimate risk when reaction time is normal but gaze is unstable. Propose new feature combinations, weighting schemes, or model architectures that increase sensitivity to eye-movement abnormalities while maintaining low false positives for sober drivers.”

In another example, the server can generate a prompt sentence such as:
“Propose a method to adjust per-driver baseline reaction time and blink frequency thresholds based on historical time-series data. The method should update means and variances using exponential moving averages and detect long-term shifts in behavior without overreacting to short-term noise. Provide formulas and criteria for when to update baseline values and when to keep them fixed.”

The server transmits such prompt sentences to the generative information processing model, receives candidate algorithm descriptions or parameter adjustment strategies, and parses them into structured configuration updates. The server can convert high-level recommendations into specific changes, such as adding new feature interaction terms, modifying threshold values, or changing neural network layer sizes. The server then validates these changes on recorded data and, if performance improves according to predefined metrics, deploys the updated configuration to the live system. This use of a generative model is not a mere substitution for human design, but a mechanism integrated into the system to automatically explore non-intuitive model configurations and feature combinations, which enhances the underlying computer-implemented classification capability.

The server also estimates an emotional state index for the user. The server extracts additional features from acoustic information, such as prosodic contours, and from image information, such as facial expression descriptors derived from facial landmarks and action units. The server uses a separate estimation algorithm, such as a multi-task neural network, that shares lower layers with the risk classifier but has additional output heads for emotional categories or continuous affective dimensions. The server uses this emotional state index to adjust the risk index, for example by reducing weight on speech-related features when the user exhibits high stress but no signs of alcohol consumption, or by increasing weight on certain eye-related features when fatigue indicators are present. By explicitly incorporating emotional context, the system reduces misclassification due to confounding non-alcohol factors and thereby improves technical performance.

In some embodiments, the server implements a multi-level warning and confirmation framework involving a third-party terminal device. When the risk index and emotional state index reach a very high level, the server transmits notifications to a remote terminal operated by a guardian or supervisor. The server requests confirmation or override information and records the responses. The server uses the outcomes of these interventions, including whether the third party agreed with the risk assessment and whether an incident occurred, as additional labels for refining the risk classifier. By integrating intervention outcome data into the model training process, the server improves calibration of the risk index and the precision of safety actions.

The described architecture produces several technical effects. The explicit time alignment of multimodal data and their storage in time-indexed buffers improves synchronization and reduces false correlations between audio and video events. The use of driver-specific normalization and dynamic correction of baselines improves classification accuracy across diverse users. The combination of frame-level feature extraction, temporal modeling, and multimodal fusion increases robustness against noise and environmental variations. The integration of a generative information processing model via carefully structured prompt sentences allows the server to systematically explore novel algorithmic configurations beyond conventional human-designed heuristics, leading to improved precision and recall in risk estimation. The direct control of the moving body's propulsion system based on the computed risk index provides a concrete, real-world application of the improved computation, going beyond abstract data analysis.

The server, the terminal, and the user can be implemented in various configurations without departing from the scope of the invention. In some embodiments, the server is integrated into the vehicle as an on-board computing unit with dedicated graphics and neural processing accelerators. In other embodiments, the server is a cloud server that receives data from multiple vehicles and performs centralized processing, while the terminal handles preliminary encoding and buffering. In some variations, the speech recognition and image analysis modules are partially executed on the terminal to reduce bandwidth usage, with only feature vectors transmitted to the server. In other variations, the server replaces the neural network classifier with a gradient boosted tree ensemble to reduce computational load on resource-constrained hardware. The generative information processing model may run on a separate computing infrastructure and be accessed asynchronously, with the server updating its algorithms at scheduled times.

In each of these embodiments, the core concept remains that the server performs structured, time-aligned, feature-based, and adaptively optimized analysis of acoustic information and image information to generate a risk index used for actual control of a moving body, thereby providing a specific improvement to computer-based driver monitoring and vehicle safety systems.

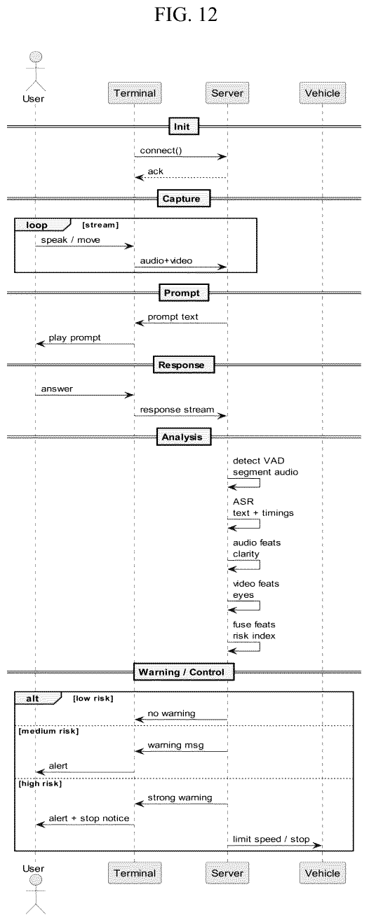

The following describes the processing flow using FIG. 12.

### Step 1:

The terminal initializes sensors and communication.

The terminal sets sampling parameters for a microphone (for example, 16 kHz, 16-bit PCM) and a camera (for example, 30 fps, 720p), and establishes a secure communication channel with the server.

Input: system configuration data stored in the terminal; network parameters.

Processing: the terminal loads configuration values, configures hardware registers of the microphone and camera, and opens a secure socket or session to the server.

Output: an active audio/video capture state and a live, authenticated connection to the server.

### Step 2:

The server initializes data structures and models.

The server allocates ring buffers or queues for acoustic information and image information, and loads model parameters for voice feature extraction, eye-feature extraction, and risk estimation into memory.

Input: configuration files, pre-trained model files, and driver profile records.

Processing: the server parses configuration files, allocates memory for buffers, initializes random seeds where necessary, and deserializes model weight matrices into internal tensor structures.

Output: initialized buffers, loaded models, and a ready state for receiving streaming data.

### Step 3:

The terminal captures and transmits multimodal data.

The terminal acquires raw audio frames from the microphone and raw video frames from the camera, timestamps each frame using a local clock synchronized with the server, compresses the streams, and sends them to the server.

Input: analog sound signals from the user; optical images of the user and cabin.

Processing: the terminal digitizes audio via an analog-to-digital converter, digitizes video via an image sensor pipeline, encapsulates data in packets with timestamps and identifiers, and transmits the packets over the network.

Output: time-stamped, compressed acoustic information and image information delivered to the server.

### Step 4:

The server receives and buffers streaming data.

The server accepts incoming packets from the terminal, decodes compressed audio and video into raw frames, and enqueues them into time-indexed buffers.

Input: compressed audio packets and compressed video packets from the terminal.

Processing: the server parses packet headers, verifies integrity checks, decodes audio and video using codec libraries, and stores frame pointers, timestamps, and metadata in ring buffer entries.

Output: synchronized acoustic frame sequences and image frame sequences stored in server memory.

### Step 5:

The server presents a prompt sentence to elicit a response.

The server selects a query from a prompt repository and sends it to the terminal for output to the user.

Input: a list of stored prompt sentences and session context (for example, last prompt type, time since last query).

Processing: the server chooses a prompt sentence such as “How are you feeling right now?” based on a selection rule (for example, round-robin or random with constraints), records the selection time, and sends the prompt text and a prompt identifier to the terminal.

Output: a prompt message transmitted to the terminal, with an associated timestamp stored on the server.

### Step 6:

The terminal outputs the prompt and records the user's response.

The terminal converts the received prompt sentence into speech and plays it through the speaker while continuing to capture audio and video of the user.

Input: prompt text and prompt identifier from the server; ongoing sensor signals.

Processing: the terminal invokes a text-to-speech engine to synthesize the prompt, mixes the synthesized audio into the playback pipeline, and simultaneously continues to sample and packetize microphone and camera data.

Output: audible query presented to the user and corresponding response audio/video captured and sent to the server.

### Step 7:

The user provides a verbal and behavioral response.

The user listens to the prompt, thinks, and speaks a natural-language answer while looking toward the driving environment.

Input: the audible prompt from the terminal.

Processing: the user generates spoken language and exhibits natural eye movements and facial expressions, which are captured as acoustic information and image information.

Output: human speech and behavior encoded into the captured sensor data streams.

### Step 8:

The server detects the start of the user's response and computes reaction time.

The server monitors incoming acoustic information to identify the first instance of speech following the prompt and calculates the reaction time.

Input: time-stamped acoustic frames and the prompt transmission timestamp.

Processing: the server applies a voice activity detection algorithm to the audio frames, computes short-time energy and spectral indicators over sliding windows, identifies the first window exceeding a speech threshold after the prompt time, and subtracts the prompt timestamp from this response start timestamp.

Output: a numerical reaction time value associated with the prompt identifier and stored in a reaction time table.

### Step 9:

The server segments the user's response audio.

The server partitions the acoustic information into utterance segments corresponding to the detected response interval.

Input: continuous acoustic frames and the detected response start time and end time (for example, last speech activity time).

Processing: the server groups contiguous frames labeled as speech into a segment, attaches segment-level metadata such as start time, end time, duration, and driver identifier, and stores pointers to these frames in a segment table.

Output: one or more speech segments representing the user's response, with clear temporal boundaries.

### Step 10:

The server performs speech recognition on the segmented audio.

The server converts each speech segment into text and token timing data.

Input: speech segments extracted from the acoustic buffer.

Processing: the server sends each segment to a speech recognition engine, receives recognized text, word tokens, and word-level timestamps, and verifies recognition confidence. The server associates the text with the corresponding segment in the database.

Output: character information and token timing arrays linked to each speech segment.

### Step 11:

The server computes acoustic feature quantities from the audio signal.

The server processes each speech segment at the signal level to derive low-level features.

Input: raw or decoded audio samples for each segment.

Processing: the server divides the segment into overlapping frames, applies a window function, computes short-time energy, spectral coefficients using fast Fourier transforms, pitch estimates, and loudness contours; the server then aggregates frame-level metrics into segment-level statistics such as average fundamental frequency, variance of volume, and spectral moments.

Output: a feature vector of acoustic signal descriptors for each speech segment.

### Step 12:

The server computes temporal and linguistic speech features from character information.

The server analyzes the recognized text and token timing to extract higher-level speech behavior metrics.

Input: character information, token lists, and token timestamps for each segment.

Processing: the server calculates utterance speed as tokens per second, detects pauses by gaps between tokens longer than a silence threshold, counts word repetitions, and identifies self-corrections based on low-confidence tokens followed by replacements. The server summarizes these into numerical features.

Output: a feature vector of temporal and linguistic descriptors for each speech segment.

### Step 13:

The server evaluates clarity of utterance and utterance pattern.

The server combines acoustic signal features and temporal/linguistic features to produce clarity and pattern scores.

Input: concatenated feature vectors for each speech segment.

Processing: the server feeds normalized features into a trained neural network or classifier, computes layer activations, and obtains output neurons representing a clarity score and an utterance pattern score. The server optionally applies calibration or scaling to map outputs into a fixed range.

Output: a clarity-of-utterance score and an utterance-pattern score for each segment.

### Step 14:

The server extracts eye-related features from image information.

The server processes video frames to detect the face region and eye region and derive blink and gaze metrics.

Input: time-stamped image frames corresponding to the same interval as the speech segment.

Processing: the server runs a face detector on each frame, locates eye regions via facial landmarks, computes eyelid opening degree, detects open/closed states, counts blinks by open-closed-open transitions, measures blink duration from timestamps, estimates gaze direction from pupil position, and computes variation of gaze over the time window.

Output: a time series of eye-related measurements and aggregated values (blink count, average blink duration, eyelid opening statistics, gaze direction variance) for the interval.

### Step 15:

The server computes attention and eye-movement abnormality indices.

The server transforms eye-related measurements into indices representing attention and abnormal behavior.

Input: sequences of eye feature vectors over a recent time window.

Processing: the server inputs the sequences into a temporal model such as a recurrent neural network, computes hidden states across time, and outputs an attention state index and an eye-movement abnormality index. The server normalizes values based on driver-specific baselines in the driver profile.

Output: an attention index and an eye-movement abnormality index corresponding to the same time period as the speech segment.

### Step 16:

The server normalizes multimodal features using driver profiles.

The server adjusts raw metrics to account for each driver's typical behavior.

Input: reaction time, clarity score, utterance pattern score, attention index, eye-movement abnormality index, and driver profile statistics (for example, baseline means and standard deviations).

Processing: the server computes standardized scores such as z-scores for each metric by subtracting baseline means and dividing by baseline standard deviations, and stores these normalized values in a multimodal feature vector.

Output: a normalized multimodal feature vector for the driver at the current time.

### Step 17:

The server calculates a risk index from the normalized features.

The server estimates alcohol-related impairment using a trained classifier.

Input: the current normalized multimodal feature vector and, optionally, recent historical vectors (for example, from the last several minutes).

Processing: the server feeds the vector into a machine learning model such as a neural network or a gradient-boosted tree ensemble, computes internal decision functions, and outputs a continuous risk index value representing probability or degree of alcohol influence.

Output: a numerical risk index associated with the driver and the current time.

### Step 18:

The server updates time-series records and driver baselines.

The server logs the current features and indices and refines long-term driver-specific baselines.

Input: the multimodal feature vector, the risk index, and existing time-series data for the driver.

Processing: the server writes a new record containing timestamp, feature values, and risk index into a time-series database, and updates baseline parameters using algorithms such as exponential moving averages while applying stability constraints to avoid drastic changes.

Output: updated time-series records and refined baseline parameters stored in the driver profile.

### Step 19:

The server determines warning actions and vehicle control commands.

The server compares the risk index with one or more thresholds and decides whether to warn the user or intervene in vehicle control.

Input: current risk index, emotional state index if available, and configured threshold values.

Processing: the server evaluates decision rules or a policy function to classify the risk level (for example, normal, caution, high risk), generates appropriate warning messages, and, for high risk levels, produces control commands for speed reduction, engine output limitation, or automatic stopping.

Output: warning information to be sent to the terminal and control commands to be sent to the moving body control device.

### Step 20:

The terminal outputs warnings to the user.

The terminal receives warning information from the server and presents it to the user via visual and auditory channels.

Input: warning text, audio identifiers, or control flags from the server.

Processing: the terminal displays warning messages on a screen, lights warning indicators on the dashboard, and plays warning sounds or synthesized speech through the speaker.

Output: perceptible alerts to the user indicating possible alcohol-related impairment and requested actions.

### Step 21:

The server interacts with a third-party terminal when necessary.

The server notifies a remote third-party device and requests confirmation or consent for high-severity safety actions.

Input: high risk index, emotional state index, and pre-configured contact information for a third party.

Processing: the server formats a notification containing current risk level and context, sends it to the third-party terminal, awaits a response indicating consent, rejection, or no response, and logs the outcome for later learning.

Output: third-party notification messages and received consent or override information.

### Step 22:

The server generates prompt sentences for a generative AI model.

The server creates text instructions describing current model performance and desired improvements for use with a generative AI model.

Input: historical error statistics, confusion patterns, current model configuration, and logged interventions.

Processing: the server assembles this information into a structured prompt sentence such as “Design an improved algorithm to integrate reaction time, speech clarity, voice pattern features, blink frequency, blink duration, and gaze direction variance into a risk index,” and stores or transmits the prompt to the generative AI environment.

Output: one or more prompt sentences describing algorithm design or update tasks for the generative AI model.

### Step 23:

The server updates algorithms and thresholds based on generative AI outputs.

The server receives candidate algorithm modifications or parameter suggestions derived from the generative AI model and applies validated changes to its internal configuration.

Input: textual descriptions of proposed feature combinations, model architectures, or threshold adjustments generated in response to the prompt sentences.

Processing: the server parses the proposals, maps them to machine-readable configuration parameters (for example, new weightings, added features, or modified neural network layer sizes), evaluates them offline on stored data sets, and, if performance metrics improve, updates the live models and thresholds accordingly.

Output: revised model configurations and threshold values deployed in the server for subsequent processing cycles.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional systems for preventing impaired driving primarily rely on a single sensing modality, such as breath alcohol concentration or simple driver self-reporting, and apply static threshold rules to decide whether to allow vehicle engine activation. Such systems suffer from several technical limitations in terms of computer technology. First, because they do not integrate heterogeneous sensor data (for example, audio information, visual information, and breath alcohol measurements) in a unified computational pipeline, the systems exhibit low robustness and high false-positive and false-negative rates, which degrades the reliability of automated decisions taken by the underlying computing platform. Second, existing architectures typically implement rule-based processing that is hard-coded and difficult to adapt, and they do not leverage generative models to dynamically construct analysis instructions or human-readable explanations. As a result, the processing logic is rigid, not context-aware, and computational resources are not efficiently utilized in view of the richness of available sensor data. Third, where third-party confirmation is required, conventional systems often implement ad hoc communication flows that are loosely coupled with the internal decision logic, leading to fragmented state management, increased latency, and difficulty in reproducing or auditing decision paths. This fragmentation manifests as distributed, inconsistent data structures and processes across devices, and thus constitutes a problem of computer system design rather than simply a human-factor issue. Fourth, existing systems generally lack an integrated mechanism for automatically generating explanatory narratives of system behavior, based on logged data, using a generative model. Without such a mechanism, users and administrators face difficulties in understanding and validating how the system arrived at a particular decision, and computing devices must be manually queried and inspected, which is inefficient and error-prone. Accordingly, there is a need for an improved computer-implemented system that (i) programmatically generates prompt sentences to control a generative AI model for multi-modal driver-state analysis, (ii) integrates sensor analysis, machine-learned evaluation, third-party communication, and engine control into a coherent processing architecture, and (iii) automatically generates explanatory text based on recorded histories, thereby improving the technical functioning of the computer system as a whole in terms of accuracy, traceability, and manageability of impaired-driving control decisions.

The specific processing by the specific processing unit 290 of the data processing device 12 in Example 2 is realized by the following means.

The present invention provides a server comprising a processor configured to acquire audio information and visual information of a driver, generate a prompt sentence to instruct a generative artificial intelligence model to analyze reaction speed, speech state, and audio patterns, and determine presence and degree of alcohol influence based on an analysis result from the generative artificial intelligence model; acquire numerical information from a detection device configured to detect an alcohol concentration in breath of the driver, and determine whether the driver is under alcohol influence by comparing the numerical information with a reference value; integrate an analysis result of the audio information and the visual information with a comparison result of the alcohol concentration, and evaluate presence and degree of alcohol influence on the driver comprehensively by using machine learning; based on the comprehensive evaluation, when the driver is determined to be under alcohol influence, transmit notification information to a third-party terminal, receive response information from the third-party terminal, and determine presence or absence of consent; generate control information indicating permission or prohibition of activation of a power unit of a vehicle according to the presence or absence of the consent and the comprehensive evaluation, and transmit the control information to a control device of the vehicle so as to operate a safety mechanism in which the power unit is not activated by the driver alone; and record the notification information, the response information, an evaluation result, and the control information as a history, generate a prompt sentence for input to a generative artificial intelligence model for generating an explanatory text of an operation situation based on the history, and acquire the explanatory text output from the generative artificial intelligence model. This enables an integrated computer-implemented architecture that improves technical performance by more accurately and robustly determining impaired driving states through multi-modal, machine-learned evaluation, by tightly coupling third-party communication and engine control within a unified state-managed processing pipeline, and by automatically generating explanatory narratives from logged data using generative modeling, thereby enhancing system traceability, auditability, and manageability while reducing computational inefficiencies and decision errors in the underlying computing system.

The term “processor” refers to a hardware or virtual processing unit, such as a central processing unit or microcontroller, configured to execute instructions of one or more programs to perform the functions described herein.

The term “audio information” refers to data representing sound produced by a driver, including but not limited to spoken utterances, prosody, timing, and other acoustic characteristics, in analog or digital form.

The term “visual information” refers to image or video data capturing a driver, including but not limited to facial features, eye regions, and head position, suitable for computational analysis.

The term “driver” refers to a human operator responsible for controlling a vehicle and subject to evaluation of alcohol influence by the system.

The term “prompt sentence” refers to a machine-readable instruction string or sequence of tokens provided as input to a generative artificial intelligence model to specify an analysis task or a text-generation task.

The term “generative artificial intelligence model” refers to a trained computational model, such as a neural network based large language model or multi-modal model, configured to generate output data including texts or analysis results in response to input prompts.

The term “reaction speed” refers to a temporal characteristic derived from driver-related data, indicating latency or response time in speech or behavior, as computed or inferred by the system.

The term “speech state” refers to one or more linguistic or paralinguistic attributes of driver speech, including articulation clarity, fluency, slurring, and rhythm, as detected or evaluated by the system.

The term “audio patterns” refers to structural features or statistical regularities in audio information, including frequency components, temporal envelope, and prosodic contours, that are used by the system for analysis.

The term “detection device” refers to a hardware sensing unit configured to measure a physical or chemical quantity related to alcohol in breath of the driver and to output corresponding numerical information.

The term “alcohol concentration in breath” refers to a quantitative measure of alcohol content present in exhaled air from the driver, expressed in any suitable unit such as percentage or mass per volume.

The term “numerical information” refers to data in numeric form representing a measured or computed value, including at least the measured alcohol concentration in breath.

The term “reference value” refers to a predetermined or adaptively determined threshold value used as a comparison baseline for deciding whether the driver is under alcohol influence.

The term “comparison result” refers to an outcome of a computational operation that compares numerical information with the reference value, including at least an indication whether the numerical information exceeds, meets, or falls below the reference value.

The term “machine learning” refers to a computational technique in which a model is trained on data to learn parameters or patterns and is then used to perform tasks such as classification, regression, or scoring without being explicitly programmed with fixed rules.

The term “presence and degree of alcohol influence” refers to a binary or multi-level evaluation indicating whether the driver is affected by alcohol and, when affected, to what severity or intensity.

The term “comprehensive evaluation” refers to an aggregated assessment derived from integration of multiple analysis results and comparison results, representing an overall determination of the driver's alcohol influence state.

The term “communication function” refers to hardware and software components that enable data exchange between the server and external devices or networks, including wired or wireless communication interfaces and protocols.

The term “notification information” refers to message data transmitted from the server to a third-party terminal to report an evaluation result or request consent related to activation of a power unit.

The term “third-party terminal” refers to an information processing device operated by a person other than the driver, such as a mobile communication device or computing terminal, configured to receive notification information and transmit response information.

The term “response information” refers to data transmitted from the third-party terminal to the server indicating consent, refusal, or other status in response to notification information.

The term “consent” refers to an affirmative or negative decision by a third party regarding permission for activation of the power unit, as represented in response information.

The term “control information” refers to command data generated by the processor indicating whether activation of a power unit of a vehicle is permitted or prohibited, possibly including associated reasons or conditions.

The term “power unit” refers to a propulsion-related assembly of a vehicle, including at least an engine or motor, whose activation enables the vehicle to move.

The term “control device of the vehicle” refers to an electronic control unit or similar computing module configured to receive control information from the server and to control activation of the power unit.

The term “safety mechanism” refers to a control arrangement implemented by hardware and software that prevents activation of the power unit under specified conditions, including at least the condition that the driver alone cannot activate the power unit when under alcohol influence.

The term “history” refers to stored records representing past events and data, including at least notification information, response information, evaluation results, and control information associated with particular sessions.

The term “operation situation” refers to a state or sequence of events relating to use of the system and the vehicle, including measurements, evaluations, communications, and control actions in a given session.

The term “explanatory text” refers to human-readable narrative information generated by a generative artificial intelligence model that describes or explains an operation situation based on the history.

The term “emotional state” refers to an inferred affective condition of the driver, such as stress level, calmness, or agitation, as evaluated by a generative artificial intelligence model from audio information, visual information, or other data.

In one embodiment, a server, a terminal, and a vehicle-side control device cooperate to implement a system that evaluates alcohol influence of a driver by using multi-modal sensor data, machine learning, and a generative AI model, and that controls activation of a power unit of a vehicle based on a comprehensive evaluation and third-party consent.

Server includes at least one processor, a memory, a network interface, and a non-transitory storage device. Server executes software components such as an application layer implemented, for example, using a web framework (e.g., a server-side framework), a database management system (e.g., a relational database engine), and a machine learning inference engine. Server stores program modules including a multi-modal feature extraction module, a machine learning evaluation module, a generative AI interface module, a consent management module, and a power-unit control interface module. Server also maintains a schema of data structures including driver profiles, sensor records, evaluation results, notification records, and engine control logs.

Terminal includes at least one processor, a display, an input interface, a communication module, and an operating system capable of executing an application for presenting notifications and capturing responses. Terminal in some embodiments is a mobile communication device used by a third party, and in other embodiments is an in-vehicle display unit operated by the driver. Terminal exchanges data with Server via a wireless communication network.

User operates the vehicle and interacts with the system as the driver, or operates Terminal as the third party or as an administrator. User as the driver provides audio information by speaking, provides visual information by being observed by a camera, and provides breath alcohol information by exhaling into a detection device. User as the third party reviews notifications on Terminal and inputs consent or refusal. User as an administrator accesses diagnostic explanations generated by the generative AI model via a browser-based interface presented by Server.

Server acquires audio information of the driver via a microphone connected to a vehicle-side input unit or to Terminal. Server receives digitized audio data encapsulated in data structures that include time stamps, driver identifiers, sampling rate metadata, and channel information.

Server applies a pre-processing pipeline that performs noise reduction, voice activity detection, and segmentation into utterance-level audio frames. Server computes audio features such as Mel-frequency cepstral coefficients, pitch contour, energy envelope, and articulation-related features including formant trajectories. These features constitute low-level feature vectors that are stored in memory and used as inputs to subsequent models.

Server acquires visual information of the driver via a camera arranged in an instrument panel or ceiling of the vehicle. Server receives digital image frames and sequences labeled with time stamps and driver identifiers. Server executes an image pre-processing module that performs face detection, eye-region extraction, and head pose estimation by using a convolutional neural network. Server computes visual feature vectors including gaze direction estimates, blink frequency, eyelid closure ratio, and micro head-movement patterns.

Server associates visual feature vectors with corresponding audio feature vectors via time alignment based on time stamps, and stores the aligned sequences in a multi-modal record structure.

Server acquires numerical information of breath alcohol concentration from a detection device that measures alcohol content in exhaled air. The detection device includes a sensor element (such as an electrochemical sensor), an embedded microcontroller, and a communication interface. Server receives sensor outputs as numerical values along with calibration parameters and environmental metadata. Server stores breath alcohol measurements in a structured table with fields including driver identifier, sensor identifier, raw measurement, temperature compensation value, and computed standardized concentration.

Server executes a machine learning evaluation module that integrates audio features, visual features, and breath alcohol measurements. In one embodiment, Server uses a neural network architecture that includes a first sub-network for audio feature processing, a second sub-network for visual feature processing, and a fusion network for joint evaluation. Server, for example, uses a recurrent neural network, such as a long short-term memory network, to process sequential audio features and outputs a latent representation of speech-state and reaction-speed characteristics. Server uses a convolutional or recurrent architecture for visual feature sequences to derive a latent representation of gaze stability, blink patterns, and drowsiness-related characteristics. Server concatenates or otherwise fuses the audio latent vector, the visual latent vector, and a normalized breath alcohol scalar into a fused feature vector. Server feeds this fused feature vector into a fully connected classifier network that outputs a probability distribution over discrete alcohol influence levels and a continuous severity score.

Server configures the neural network by training it on historical multi-modal data. Server uses a labeled dataset including audio, visual, and breath measurements with ground-truth labels of alcohol influence levels derived from clinical or standardized tests. Server optimizes network parameters by performing mini-batch gradient descent or a variant such as Adam, using a loss function that combines cross-entropy for classification outputs and mean squared error for severity scores. Server updates weights layer-by-layer using backpropagation and monitors validation metrics such as accuracy, false positive rate, and false negative rate.

Server optionally applies data augmentation, such as adding background noise to audio or simulating lighting changes in visual frames, to improve generalization.

Server generates a prompt sentence as a textual sequence for instructing a generative AI model to perform specific analyses or to generate explanations. Server constructs the prompt sentence based on structured fields in the data records, inserting measured alcohol concentration, threshold values, feature-derived indicators, and session identifiers into a predefined template. In one example, Server generates the following prompt sentence: “Analyze the driver's state based on the following information: breath alcohol level 0.05%, threshold 0.03%, slurred speech and delayed responses observed in audio features, and increased blink frequency in eye movement features. Determine the severity of alcohol influence and describe the reasons for the determination in clear language.”

Server submits such a prompt sentence, encoded as a sequence of tokens, to a generative AI model that is implemented as a transformer-based neural network. Server configures the generative AI model with layers including multi-head self-attention, feed-forward sub-layers, and positional encodings. Server stores model parameters in memory and uses optimized matrix operations to perform inference. Server receives the generated output tokens and decodes them into an explanatory text or into structured annotations that are subsequently used in the comprehensive evaluation.

Server in certain embodiments uses a generative AI model also to evaluate emotional state of the driver. Server includes, in the prompt sentence, descriptors of prosodic features and facial expression features such as:
“Based on the following features extracted from driver speech and facial expressions, evaluate the emotional state (e.g., calm, stressed, agitated) and indicate a confidence score: monotone voice, slowed speech rate, frequent downward gaze, and reduced facial expressiveness.”

Server processes the generated text to extract an emotional-state label and an associated numeric confidence. Server then adjusts the severity score of alcohol influence by applying a rule-based or learned mapping that accounts for emotional confounds. For instance, Server reduces weight of certain slurring indicators if the emotional state is evaluated as highly stressed rather than intoxicated.

Server further generates a second class of prompt sentences for post-hoc explanation of past sessions based on a stored history. In one example, Server generates:
“Explain in plain language the events of the driving session with identifier SESSION-2026-01-29-001. The driver's breath alcohol level was 0.05%, the threshold was 0.03%, the multi-modal classifier predicted high alcohol influence with probability 0.91, a third party responded ‘AGREE’ within 120 seconds, and the vehicle power unit was allowed to activate. Provide a narrative that includes the main reasons for the influence determination and the role of third-party consent.”

Server processes the output of the generative AI model to provide administrators with a detailed, consistent explanation of system behavior without requiring manual reconstruction of events from raw logs.

Server manages consent from a third party by integrating notification, response, and control flows in a unified data model. Server, when the comprehensive evaluation indicates that the driver is under alcohol influence, constructs a notification message including evaluated severity and key sensor indicators. Server transmits this message to a third-party Terminal via a communication network. Terminal displays the message and provides input elements such as buttons or a text input area for consent or refusal. When User as the third party inputs a response such as “AGREE” or “DISAGREE,” Terminal sends this response to Server, for example by invoking a server endpoint accessible over a secure protocol.

Server receives the response, normalizes the content, and maps it to standardized consent states. Server records the mapping result, time stamps, and associated session identifiers in a consent record. Server associates the consent record with the comprehensive evaluation, thereby capturing the full decision context in a single logical entity. Server uses this unified context to generate control information for the vehicle power unit. When consent is absent, refused, or not received within a predetermined time, Server generates control information that prohibits activation of the power unit and optionally triggers additional notifications.

Server transmits control information to the vehicle control device via a dedicated communication channel. The vehicle control device is, for example, an electronic control unit coupled to an in-vehicle network. Server formats control information as a structured message that includes fields such as driver identifier, session identifier, permitted state (allowed or blocked), and validity period. The vehicle control device interprets the message and sets internal flags that enable or disable ignition or power-on sequences. In this manner, Server exerts direct influence on physical operation of the power unit, so that the system is not limited to abstract data processing but results in actual control of physical machinery.

Server improves computer technology in several ways. First, by employing a multi-modal fusion neural network and an auxiliary generative AI model that are tightly integrated into a unified architecture, Server reduces false positives and false negatives compared to single-modality or purely rule-based systems. This improved accuracy reduces unnecessary blocking of vehicle activation and missed detections of actual impairment, resulting from a more efficient use of computational resources through learned feature representations that capture complex correlations between audio, visual, and breath data. Second, by generating and managing prompt sentences and their responses as structured data, Server creates a consistent interface layer between deterministic evaluation modules and generative models.

This interface stabilizes the behavior of the generative AI model, allowing repeatable and auditable outputs, which addresses technical problems of variability, prompt drift, and uncontrolled natural language behavior.

Server also improves data management by storing coherent session objects that bundle sensor streams, model outputs, consent events, and control actions. This structure enables efficient querying and analysis, reduces redundancy, and supports incremental updates without reprocessing entire logs. Because all components write to and read from a normalized schema, Server can execute batch operations, such as recalculating severity scores with updated models or regenerating explanations, with predictable resource consumption and reduced I/O overhead.

Terminal benefits from reduced communication load because Server can pre-compute summarized information and only transmit concise notification messages instead of streaming full sensor data or raw logs. This reduces bandwidth usage and latency. Terminal does not perform complex inference, thereby saving local computation and battery power. Instead, Terminal primarily performs presentation and simple input handling.

User interacts with the system in an improved manner because the system offloads complex reasoning to specialized models and provides understandable explanations. User as an administrator does not need to inspect raw sensor streams or low-level logs; instead, User reads explanatory texts that are generated by the generative AI model and backed by stored histories. This approach improves human-computer interaction without merely automating human manual review, because the system derives explanations based on internal model states and structured histories that humans could not practically maintain or traverse in real time.

Server employs specific rules and non-conventional procedures to coordinate deterministic models and generative models. For example, Server may enforce that a generative explanation is accepted only if certain internal consistency checks pass, such as correspondence between mentioned values in the generated text and stored numeric fields.

Server may also perform a template-based post-processing step to normalize generated outputs. These procedures go beyond simple replacement of human narrative writing and instead impose machine-verifiable constraints on generative outputs, thereby improving reliability and integrating generative models as controlled components of a technical system.

Server, in alternative embodiments, can replace certain sub-networks or generative models while preserving the overall data flow. For instance, Server may use a different neural network architecture, such as a transformer-based encoder for multi-modal fusion, or employ a different training objective that includes penalty terms for misalignment between breath measurements and audio-visual indicators. Server may also modify the emotional-state adjustment mechanism to include separate sub-models specialized for stress estimation or fatigue detection. These variations all remain within the scope of the system so long as Server acquires multi-modal features, integrates them with breath alcohol measurements, and uses generative AI through controlled prompt sentences to support evaluation and explanation.

Server can be implemented as a cloud-based service that supports multiple vehicles and multiple Terminals simultaneously, or as an on-premises computing node inside a fleet-management environment. Terminal may be implemented as an embedded in-vehicle display, a smartphone application, or a web-based interface. Vehicle control devices may vary depending on vehicle type, including internal combustion engines or electric motors, and may interface with Server through different communication protocols. By adapting to these variations while maintaining the core processing architecture, the system flexibly applies the same fundamental techniques to diverse deployment environments.

In summary, Server uses concrete data structures, specific neural network architectures, structured prompt sentences, and rule-based coordination mechanisms to implement a system that does more than merely automate human decision-making. Server improves technical performance by enhancing accuracy of impairment detection, reducing communication overhead, organizing data in a more computationally efficient manner, and enabling robust, auditable control of a physical power unit through a combination of deterministic and generative computational modules.

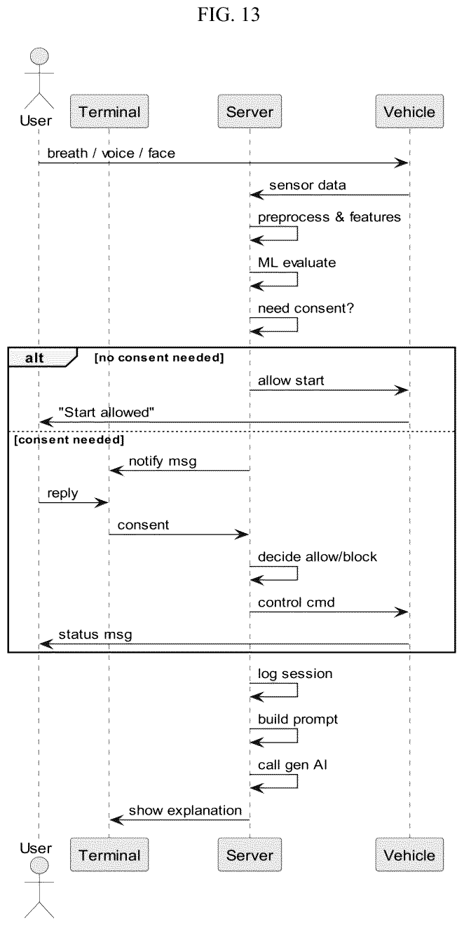

The following describes the processing flow using FIG. 13.

### Step 1:

User provides raw data by speaking, being captured by a camera, and exhaling into a breath detection device installed in a vehicle. User, as the driver, speaks predetermined phrases or engages in natural conversation, looks forward toward the road, and exhales into a mouthpiece connected to the breath detection device for a specified duration. The input to this step is human speech, facial and eye movements, and exhaled breath. The output of this step is analog audio signals, optical images, and gas sensor signals that are ready to be digitized by connected hardware.

### Step 2:

Server receives digitized sensor data from vehicle-side modules, including audio frames, image frames, and numerical alcohol measurements. Server obtains audio samples as digital time-series, visual frames as digital images or video frames, and breath alcohol measurements as numerical values with associated metadata. The input to this step is raw digitized sensor data transmitted over a communication interface. The output of this step is structured sensor records stored in memory, each record including a driver identifier, timestamps, and modality-specific data fields.

### Step 3:

Server pre-processes the audio data to extract low-level speech features. Server applies noise reduction and voice activity detection to the audio stream, segments the audio into analysis windows, and computes features such as Mel-frequency cepstral coefficients, pitch, and energy. The input to this step is a sequence of raw audio samples with timestamps. The output of this step is a sequence of audio feature vectors, each vector representing statistical and spectral characteristics for a corresponding time window.

### Step 4:

Server pre-processes the visual data to derive eye and face-related features. Server detects the driver's face in each frame, locates eye regions, and estimates gaze direction, blink occurrence, and eyelid opening ratio by applying image-processing and convolutional neural network operations. The input to this step is a sequence of image frames with timestamps.

The output of this step is a sequence of visual feature vectors that encode gaze direction, blink frequency, and head pose for corresponding time intervals.

### Step 5:

Server normalizes and validates the breath alcohol measurement received from the detection device. Server uses calibration parameters and environmental information to convert raw sensor readings into a standardized alcohol concentration value and compares the value with acceptable ranges to detect sensor errors. The input to this step is a raw numerical measurement with associated calibration data. The output of this step is a validated, normalized alcohol concentration value, expressed in a predefined unit and linked to the current driving session.

### Step 6:

Server aligns and fuses the audio feature vectors, visual feature vectors, and normalized alcohol concentration into a unified multi-modal representation. Server uses timestamps to match audio and visual feature windows and appends the alcohol concentration value as an additional feature dimension or separate input channel. The input to this step is sequences of audio and visual feature vectors and a scalar alcohol value. The output of this step is a fused feature tensor that combines multiple modalities for the same time period or session.

### Step 7:

Server evaluates alcohol influence by executing a machine learning model on the fused feature tensor. Server feeds the fused features into a trained neural network that outputs a probability distribution over influence levels and a continuous severity score. The input to this step is the fused feature tensor. The output of this step is an evaluation result including a classification label (for example, “no influence,” “moderate influence,” “high influence”) and a numeric severity score, which are stored as part of the session record.

### Step 8:

Server determines whether a third-party consent procedure is required based on the evaluation result and a reference threshold. Server compares the severity score and classification label with configuration parameters, and decides if the driver should be treated as under alcohol influence for control purposes. The input to this step is the evaluation result and threshold settings. The output of this step is a decision flag indicating “consent required” or “consent not required” for the current session.

### Step 9:

Server generates a prompt sentence for a generative AI model to obtain a detailed analysis or explanation of the driver's state. Server constructs a text string that embeds the measured alcohol concentration, threshold, speech features, visual indicators, and preliminary classification into a natural-language instruction. The input to this step is structured evaluation data and configuration templates. The output of this step is a prompt sentence such as:
“Analyze the driver's condition based on breath alcohol level 0.05%, threshold 0.03%, detected slurred speech, delayed responses, and frequent blinking. Describe the severity of alcohol influence and provide the main reasons for your assessment.”

### Step 10:

Server sends the generated prompt sentence to a generative AI model and receives an explanatory text response. Server encodes the prompt, performs inference on a transformer-based model, and decodes the generated tokens into readable text. The input to this step is the prompt sentence. The output of this step is an explanatory text that describes the driver's influence level and contributing factors, which is then stored as part of the explanatory record for the session.

### Step 11:

Server optionally generates an additional prompt sentence for the generative AI model to evaluate the driver's emotional state. Server composes a sentence that describes prosodic and facial features, such as speech rate, pitch variation, gaze direction, and facial expressiveness. The input to this step is extracted emotional indicators derived from audio and visual features. The output of this step is a prompt sentence, for example:
“Based on the following behavioral features-monotone voice, slowed speech rate, frequent downward gaze, and reduced facial expression-evaluate the driver's emotional state (calm, stressed, agitated) and provide a confidence score.”

### Step 12:

Server obtains an emotional-state evaluation from the generative AI model and adjusts the alcohol influence severity accordingly. Server parses the generated text to extract an emotional label and a confidence value, and applies a predefined mapping to increase or decrease the severity score when certain emotional states are detected. The input to this step is the emotional-state explanatory text and the original severity score. The output of this step is an adjusted severity score and updated classification label that better distinguishes alcohol influence from emotional stress or fatigue.

### Step 13:

Server generates a notification message to be sent to a third-party Terminal when consent is required. Server formats a concise message that includes the driver identifier, measured alcohol level, threshold, evaluated influence level, and a request for consent. The input to this step is the adjusted evaluation result and the consent-required decision flag. The output of this step is a notification text, for example: “The driver associated with this message has an alcohol level of 0.05% (threshold 0.03%) and is evaluated as under alcohol influence. Do you consent to activation of the vehicle power unit? Reply with AGREE or DISAGREE.”

### Step 14:

Terminal receives the notification message from Server and presents it to the third-party User. Terminal, running a messaging or dedicated application, displays the notification text and provides an input interface such as quick-reply buttons or a text field. The input to this step is the notification message delivered over the network. The output of this step is a displayed prompt on the Terminal screen, ready for User input.

### Step 15:

User, acting as the third party, reviews the notification and inputs a consent response using Terminal. User selects or types a response, such as “AGREE” or “DISAGREE,” and confirms the transmission. The input to this step is the displayed message on Terminal. The output of this step is a response message composed by the User and sent back from Terminal to Server.

### Step 16:

Server receives the consent response from Terminal and converts it into a standardized consent status. Server parses the textual content, normalizes the case and whitespace, and matches it against predefined patterns to determine whether the response indicates consent, refusal, or an unrecognized input. The input to this step is the raw response message. The output of this step is a consent status value such as “granted,” “denied,” or “invalid,” stored together with a timestamp and session identifier.

### Step 17:

Server combines the consent status with the comprehensive alcohol influence evaluation to generate control information for the vehicle power unit. Server applies decision rules that consider both the severity of influence and the presence or absence of consent to decide whether to allow or block activation. The input to this step is the adjusted evaluation result and the consent status. The output of this step is structured control information indicating “activation allowed” or “activation prohibited,” together with reasons, which is prepared for transmission to the vehicle control device.

### Step 18:

Server transmits the control information to the vehicle control device and thereby influences physical activation of the power unit. Server encodes the decision into a control message, sends it over a secure communication channel, and logs the delivery status. The input to this step is the control information generated in the previous step. The output of this step is a received command at the vehicle control device that either enables or disables ignition or power-on, resulting in a concrete change in the operational state of the power unit.

### Step 19:

Terminal in the vehicle displays the final decision to the driver, informing whether the power unit can be activated. Terminal receives status feedback from the vehicle control device or Server and renders a message such as “Engine start allowed. You may start driving.” or “Engine start blocked due to alcohol influence and missing consent.” The input to this step is the status information received from the control device or Server. The output of this step is a human-readable message presented to the driver for guidance.

### Step 20:

Server records all relevant data from the session, including sensor measurements, feature vectors, evaluation results, prompt sentences, generative AI outputs, notifications, responses, and control decisions, into a persistent history. Server organizes these elements under a session identifier and writes them into database tables designed for efficient retrieval and auditing. The input to this step is the collection of all intermediate and final data objects generated during the session. The output of this step is a complete, structured history that can be used later for analysis, retraining of models, and generation of explanatory narratives.

### Step 21:

Server uses the stored history to generate a post-hoc prompt sentence for the generative AI model to create a narrative explanation of the entire session. Server selects key values from the history, such as measured levels, classification scores, timestamps of consent, and control outcomes, and inserts them into an explanatory template. The input to this step is the structured session history. The output of this step is a summarizing prompt sentence that instructs the generative AI model to describe what happened and why the final decision was made.

### Step 22:

Server obtains a narrative explanation from the generative AI model based on the post-hoc prompt sentence and stores the explanation for later display to an administrator via Terminal. Server decodes generated tokens into text, links the explanation to the session record, and makes it retrievable through an administrative interface. The input to this step is the summarizing prompt sentence and the model's output tokens. The output of this step is a human-readable explanation that can be presented to an administrator as a concise description of the system's technical and decision-making behavior in the session.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional driver monitoring systems for preventing drunk or otherwise unsafe driving typically rely on isolated sensor thresholds or static rule sets, such as comparing a single breath-alcohol value to a fixed limit or checking a simple facial landmark against a preset pattern. These systems suffer from several technical deficiencies as computer-implemented technologies.

First, such systems generally process heterogeneous sensor data streams (audio, video, alcohol concentration, and contextual information) in separate pipelines, without a unified representation or adaptive integration. As a result, the computing apparatus cannot reliably infer complex driver states, such as combined alcohol influence and emotional instability, from noisy and partially conflicting sensor inputs. This leads to high false-positive and false-negative decision rates, which, in turn, degrade the usability and safety of the overall control system.

Second, existing architectures typically hard-code decision logic for determining engine activation, third-party confirmation, or autonomous-driving engagement in static program code. When new behavioral patterns, sensor modalities, or regulatory constraints arise, these systems require manual reprogramming or retraining and cannot dynamically refine their inference or control strategies at runtime. Consequently, the processor is under-utilized as a general-purpose computing resource and cannot flexibly adapt to evolving operating environments.

Third, many systems that incorporate machine learning models treat those models as opaque components, without explicit mechanisms to coordinate them with higher-level reasoning engines. In particular, there is no standardized interface by which a processor can pass structured, multimodal driver-state features to a generative AI model via prompt sentences, receive back interpretable decisions or explanations, and then algorithmically reconcile those results with pre-existing control information. This absence of an integrated, prompt-driven reasoning layer prevents the processor from improving risk estimation quality and from generating transparent, context-aware control signals.

Fourth, current driver assistance platforms often lack a robust orchestration framework for end-to-end control actions, such as combining local feature extraction, server-side inference, third-party communication, and engine or power-unit control into a coherent, state-driven workflow. Without such orchestration, the underlying computer technology does not effectively transform raw sensor data into safety-critical control outputs in a deterministic and auditable manner, particularly in scenarios requiring third-party approval or real-time activation of an automatic driving function.

Accordingly, there is a need for an improved computer-implemented system in which a processor (i) acquires and fuses multimodal driver-state information, (ii) computes a comprehensive risk index using trained information processing models, (iii) leverages generative AI models via prompt sentences to refine decisions and generate explanations, and (iv) outputs control information that reliably governs activation of an energy conversion device, operation of an automatic driving function, and third-party confirmation workflows.

Such a system should improve the technical functioning of the underlying computer architecture by enhancing data processing, decision quality, adaptability, and transparency in safety-critical vehicle control.

The specific processing by the specific processing unit 290 of the data processing device 12 in Application Example 2 is realized by the following means.

The present invention provides a server comprising a processor configured to acquire voice information and image information of a driver, generate prompt sentences for instructing a generative AI model to perform extraction and evaluation of response time, speech clarity, voice features, and eye-movement features, and obtain voice evaluation information and eye-movement evaluation information based on outputs of the generative AI model and image processing; to integrate the voice evaluation information and the eye-movement evaluation information with alcohol concentration information of breath of the driver and history information indicating a state of the driver, and to calculate, by using a trained information processing model, an evaluation value indicating presence or absence of drinking of the driver and an influence degree due to drinking of the driver and to calculate a comprehensive risk index indicating drivability safety of the driver based on the influence degree and state information including an emotional state of the driver; to generate a prompt sentence for instructing the generative AI model to generate, based on the comprehensive risk index and a feature set including the voice evaluation information and the eye-movement evaluation information, a decision and an explanation relating to permission or prohibition of activation for the driver and necessity of third-party confirmation, to input the prompt sentence together with structured data summarizing the feature set to the generative AI model, and to correct control information, which determines at least one of permission or prohibition of activation of an energy conversion device, an operating state of an automatic driving function, and necessity of third-party confirmation, based on the decision and the explanation obtained from the generative AI model; and to output, based on the corrected control information, alert information or driving prohibition information to the driver via an information display device, to transmit approval request information to a third-party information processing device via a communication device, and to output a control signal to a control device for the energy conversion device so as to realize at least one of a state in which the energy conversion device is not activated by the driver alone, a state in which the automatic driving function operates preferentially, and a state in which activation of the energy conversion device is permitted. This enables the computer system to transform heterogeneous driver-state data into a unified risk representation and to dynamically refine safety-critical control decisions through coordinated use of trained models and generative AI models, thereby improving the accuracy, adaptability, and transparency of engine activation control and automatic driving control as technical operations of the underlying computing apparatus.

The term “processor” refers to a hardware information processing element, such as a central processing unit or a microcontroller, that executes instructions to perform acquisition, analysis, integration, and control operations on data in accordance with a stored program.

The term “voice information” refers to electronic data representing sound produced by a driver, including at least one of raw audio waveforms and feature values derived from such audio waveforms.

The term “image information” refers to electronic data representing at least one still image or a sequence of images of a driver, including a facial region and an eye region, acquired by an imaging device.

The term “driver” refers to a person who is authorized or intends to operate a vehicle and whose state is monitored by the system.

The term “response time” refers to a time interval between presentation of a stimulus, such as a question or instruction, and onset of a vocal response by the driver as detected from voice information.

The term “speech clarity” refers to a quantitative or qualitative measure of how clearly and correctly a driver's speech is articulated, including at least one of slurring, mispronunciation, and phoneme timing irregularity derived from voice information.

The term “voice features” refers to feature values extracted from voice information, including at least one of pitch, energy, speaking rate, spectral distribution, rhythm, and amplitude variation.

The term “eye-movement features” refers to feature values extracted from image information in a region around eyes of a driver, including at least one of gaze direction, gaze stability, blink frequency, and eyelid openness.

The term “voice evaluation information” refers to information indicating evaluation results relating to a driver's voice, including at least one of response time, speech clarity, and voice features derived from voice information.

The term “eye-movement evaluation information” refers to information indicating evaluation results relating to movements of a driver's eyes, including at least one of gaze direction, blink frequency, and movements around eyes derived from image information.

The term “alcohol concentration information” refers to numerical data indicating a concentration of alcohol in a driver's exhaled breath, measured by a sensing device.

The term “history information” refers to stored data indicating past states or behaviors of a driver, including at least one of past alcohol measurements, past risk evaluations, and past control decisions.

The term “trained information processing model” refers to a model implemented in software or hardware that has been trained using supervised or unsupervised learning on training data to map input features to output values such as a drinking influence degree or a risk score.

The term “evaluation value” refers to a numerical or categorical output generated by the trained information processing model representing at least one of presence or absence of drinking and an influence degree due to drinking.

The term “influence degree due to drinking” refers to a measure indicating how strongly alcohol consumption is estimated to affect driving ability of the driver, based on one or more sensor inputs and learned relationships.

The term “state information” refers to information indicating a state of a driver at a given time, including at least one of emotional state, physiological indicators, and contextual conditions.

The term “emotional state” refers to a psychological condition of a driver, including at least one of anger, anxiety, fear, sadness, calmness, and joy, inferred from at least one of facial expression features and voice features.

The term “comprehensive risk index” refers to a scalar or vector value calculated from multiple types of driver-state information, including at least the influence degree due to drinking and the emotional state, and representing an overall drivability safety level.

The term “feature set” refers to a collection of feature values derived from multiple modalities, including at least voice evaluation information and eye-movement evaluation information, optionally combined with alcohol concentration information and history information.

The term “generative AI model” refers to a machine-implemented model, such as a large language model or a generative neural network, that generates textual or structured output in response to an input including at least one prompt sentence and associated data.

The term “prompt sentence” refers to a natural-language or structured instruction string supplied to a generative AI model to specify a requested processing task, such as analysis, classification, explanation, or recommendation.

The term “decision” refers to a result generated by the generative AI model or by the processor indicating at least one of permission or prohibition of activation of an energy conversion device and necessity or non-necessity of third-party confirmation.

The term “explanation” refers to information generated by the generative AI model that describes reasons or justification for a decision, expressed, for example, in natural language.

The term “control information” refers to data generated by the processor that determines or influences subsequent control actions, including at least one of permission or prohibition of activation of an energy conversion device, an operating state of an automatic driving function, and necessity of third-party confirmation.

The term “energy conversion device” refers to a device that converts stored or supplied energy into mechanical energy for propelling a vehicle, such as an internal combustion engine or an electric motor.

The term “automatic driving function” refers to a function of a vehicle control system that autonomously controls at least one of propulsion, steering, and braking without continuous manual input from a driver.

The term “third-party confirmation” refers to a process in which an entity other than the driver, using a third-party information processing device, reviews driver-state information or a system request and provides approval information or denial information regarding activation of the energy conversion device.

The term “information display device” refers to a device such as a display panel, a speaker, or a combination thereof, that outputs visual or auditory information to the driver.

The term “communication device” refers to an apparatus that transmits and receives data over a wired or wireless communication network, including at least one of cellular communication, wireless local area communication, or short-range communication.

The term “third-party information processing device” refers to an external computing apparatus associated with a person other than the driver, such as a portable terminal or a remote server, that can receive approval request information and transmit approval information or denial information.

The term “control device for the energy conversion device” refers to an electronic control unit that receives control signals from the processor and manages activation, deactivation, or operating parameters of the energy conversion device.

The term “approval request information” refers to data transmitted from the server to a third-party information processing device requesting an approval or denial regarding activation of the energy conversion device or permission for driving.

The term “approval information” refers to data returned from the third-party information processing device indicating consent to activation of the energy conversion device or to continuation of driving.

The term “denial information” refers to data returned from the third-party information processing device indicating refusal to allow activation of the energy conversion device or continuation of driving.

The term “alert information” refers to data presented to the driver that notifies the driver of a risk condition or recommended caution, without necessarily prohibiting activation of the energy conversion device.

The term “driving prohibition information” refers to data presented to the driver indicating that driving is not permitted, for example because activation of the energy conversion device is prohibited under current conditions.

The term “structured data summarizing the feature set” refers to data arranged in a predefined format, such as key-value pairs or tabular entries, that compactly represents feature values included in the feature set for submission to the generative AI model.

The term “state in which the energy conversion device is not activated by the driver alone” refers to an operating condition in which the control device for the energy conversion device refuses activation commands originating solely from the driver, unless additional conditions such as third-party approval are satisfied.

The term “state in which the automatic driving function operates preferentially” refers to an operating condition in which a vehicle control system assigns primary control of driving operations to the automatic driving function rather than to manual input from the driver.

The term “state in which activation of the energy conversion device is permitted” refers to an operating condition in which the control device for the energy conversion device allows activation in response to a start request, based on control information indicating an acceptable risk level.

In the following embodiments, a data processing device is described as a “server,” a portable or in-vehicle computing device is described as a “terminal,” and a human operator is described as a “user.”

The server generates and stores a program that realizes the claimed system. The program is stored in a non-transitory storage medium within the server, such as a flash memory or magnetic disk, and is executed by a processor of the server. The terminal executes a complementary program that acquires sensor data from a vehicle environment and from the user and transmits structured data to the server.

The terminal uses hardware including at least one microphone, at least one camera directed toward a driver seat, at least one breath alcohol sensor, a display unit, a wireless communication interface (for example, cellular communication or wireless local area communication), and optionally local processing hardware such as a graphics processing unit or a digital signal processor. The terminal runs software components including an audio capture module, an image capture module, a sensor driver for the alcohol sensor, a local feature extraction module, and a communication client.

The server uses hardware including at least one central processing unit, at least one memory, a network interface, and optionally an accelerator such as a graphics processing unit or tensor processing unit. The server runs software components including an application server, an audio analysis module, an image analysis module, a feature fusion module, a trained information processing model module implemented on a machine learning framework (for example, a deep learning framework such as a generic tensor-based framework), a generative AI module, a control decision module, and a communication server. The server also uses a data store that maintains driver-specific records including past alcohol measurements, past risk evaluations, and past control decisions.

The terminal acquires voice information and image information of the user while the user is seated in the driver seat. The terminal converts analog audio signals from the microphone into digital samples, and the terminal converts analog optical signals from the camera into digital image frames. The terminal may also acquire alcohol concentration information by reading a numeric value output from the breath alcohol sensor. The terminal stores the acquired data in a buffer and performs local signal conditioning, such as noise reduction on the audio waveform and contrast normalization on the image frames.

The terminal generates a set of local features. For example, the terminal segments the audio stream into utterance segments and computes coarse features such as short-time energy, zero-crossing rate, and fundamental frequency. The terminal detects the onset of a response by comparing the energy of each frame with a noise floor threshold, and the terminal computes a response time as a difference between a question timestamp and a response onset timestamp. The terminal sends the audio segments, image frames, alcohol concentration values, and the local feature values to the server as structured packets, for example in a record structure in which each field has a fixed identifier.

The server receives the structured packets and performs more detailed analysis. The server uses an audio analysis module that includes a speech recognition engine. The server applies a feature extraction algorithm such as a mel-frequency cepstral coefficient extraction, pitch contour extraction, and phoneme timing estimation. The server then applies a speech recognition model to convert the audio into text, and the server computes a speech clarity index based on, for example, insertion and deletion error rates of phonemes, durations of vowels relative to consonants, and local spectral variance. These calculations occur using numeric operations such as matrix multiplications and non-linear transformations implemented by the processor.

The server uses an image analysis module that utilizes an image processing library such as a general-purpose computer vision library. The server performs face detection and eye region localization using a convolutional filter cascade or a trained convolutional network. The server tracks pupil positions frame by frame using, for example, template matching or optical flow, and the server computes gaze direction vectors and a gaze stability metric based on variance of these vectors. The server detects blinks by measuring rapid changes in eyelid aperture between consecutive frames and counts blinks per time unit to compute a blink frequency. The server aggregates these values as eye-movement evaluation information.

The server integrates voice evaluation information, eye-movement evaluation information, alcohol concentration information, and history information within a feature fusion module.

The server normalizes each feature to a common scale, for example by subtracting a mean and dividing by a standard deviation, and the server arranges the features in a fixed-length vector. The server then inputs the feature vector into a trained information processing model.

In one embodiment, the server uses a trained information processing model implemented as a deep neural network. The deep neural network may be a feed-forward network with multiple fully connected layers, each followed by a non-linear activation function such as a rectified linear unit. The input layer receives the concatenated feature vector, an intermediate hidden layer learns interactions between voice features, eye-movement features, and alcohol concentration, and the output layer generates an evaluation value indicating a probability of drinking and an influence degree due to drinking. The server trains this model offline using supervised learning. During training, the server uses a set of labeled examples in which each example includes a feature vector and a ground truth label indicating drinking influence. The server defines a loss function such as cross-entropy loss for classification and mean squared error for regression of influence degree. The server updates model weights using an optimization method such as stochastic gradient descent or an adaptive method, and the server may apply regularization or dropout to prevent overfitting.

The server stores the trained model, and at runtime the server executes forward passes of the model only, thereby transforming each input feature vector into an evaluation value. Because the model is trained to exploit correlations between heterogeneous modalities, the server can more accurately infer drinking influence compared to a linear threshold rule on a single sensor value. This multi-dimensional mapping improves the precision and recall of the system and reduces false decisions, which directly improves the technical operation of the control device for the energy conversion device.

The server evaluates an emotional state of the user. The server may run an emotion recognition model that receives both facial expression features and prosodic voice features.

The server uses combinations of features such as eyebrow curvature, mouth openness, eye squint, pitch variance, speaking rate, and energy contour to predict emotion categories such as anger, anxiety, or calmness. This emotion recognition model can be implemented as a neural network classifier trained on labeled expression and voice data. Alternatively, the server can use an external emotion recognition service that performs similar feature extraction and classification.

The server then computes a comprehensive risk index. The server defines, for example, a risk index as a weighted sum of the drinking influence degree and an emotional instability score, optionally including historical risk scores and contextual factors such as time of day. The server may also use a learned model that maps the underlying features and the intermediate evaluation values to the comprehensive risk index. The comprehensive risk index provides a scalar representation of drivability safety, which simplifies comparisons to thresholds and reduces the complexity of subsequent control logic.

The server uses a generative AI model in conjunction with prompt sentences to refine decision making and to produce explanations. The generative AI model may be a large language model trained on a corpus of technical text and conversational text and then further adapted to safety and control domains. The server generates a prompt sentence that encodes a specific instruction. For example, the server may generate a prompt sentence such as: “Given the following driver features: response time=1.4 seconds, speech clarity index=0.6, voice pitch variation=high, blink frequency=32 per minute, gaze stability=low, breath alcohol concentration=0.05, and emotional state=anger, determine whether engine activation should be allowed, and explain the reasons for your decision.”

The server embeds the feature vector in a structured text representation appended to the prompt sentence. The server transmits this composite text to the generative AI model. The generative AI model processes the tokenized text through its internal transformer architecture, computing attention weights between tokens and using multiple layers of self-attention and feed-forward networks. The model produces a textual output that includes, for example, a Boolean recommendation such as “engine activation should be denied” and an explanation describing how high alcohol concentration and anger combine to create elevated risk.

The server parses the textual output to extract structured decision and explanation content. For example, the server may use pattern matching to identify phrases such as “allow” or “deny,” and the server may map these phrases to internal decision codes. The server can then adjust control information by reinforcing or adjusting the thresholds used by the trained information processing model, or by adding an explanation string that will be displayed to the user.

The server further uses generative AI models to classify emotional state and to compute correction amounts for the drinking influence degree. For instance, the server may generate a prompt sentence such as:
“Evaluate the driver's emotional state from these facial expression features and voice features, and suggest a correction factor to be applied to the drinking influence score, increasing the score when the driver appears angry or anxious.”

The server supplies the current feature set to the generative AI model, receives an adjusted emotional classification and a numeric correction factor, and then updates the comprehensive risk index accordingly. This dynamic adjustment allows the system to adapt its risk evaluation to complex patterns that may not be fully captured by static models.

The server generates control information based on the comprehensive risk index and the recommendations from the generative AI model. The server may define multiple threshold regions for the comprehensive risk index. For example, when the risk index is below a first threshold, the server generates control information that allows activation of the energy conversion device without any third-party confirmation; when the risk index is between the first threshold and a second threshold, the server generates control information that permits activation only after a warning is displayed to the user; when the risk index exceeds the second threshold, the server generates control information that prohibits direct activation and requires third-party confirmation or that triggers an automatic driving function.

The server outputs the control information in the form of a control signal to a control device for the energy conversion device. The control device may be an electronic control unit that controls starter motor activation, fuel injection, and power electronics. The server transmits a digital signal, for example via a vehicle communication bus or a wireless channel, that sets or clears a bit representing an engine lock state. When the engine lock bit is set, the control device refuses to energize the starter motor even if the user operates a physical start control.

When the automatic driving function is available, the server can also send a signal to enable autonomous control of acceleration, braking, and steering. This set of signals constitutes a direct control of physical hardware and results in a technical effect in the real world, namely the prevention or allowance of engine activation and the operation of the automatic driving function.

The terminal displays alert information or driving prohibition information based on the control information and the explanations generated by the generative AI model. The terminal may show messages such as:
“Engine start is blocked because your breath alcohol level and your current emotional state indicate high risk.”

This feedback is not merely administrative; by presenting the internal evaluation and reasoning, the system enables the user to understand the machine's technical decision and to adjust behavior.

The server communicates with a third-party information processing device when control information indicates a need for third-party confirmation. The server sends approval request information using a communication device. The communication can be realized through a push notification, a message containing a hyperlink, or another digital message. The approval request may include a summary of features and the explanation from the generative AI model. A typical message might state:
“The driver appears to be under the influence and emotionally unstable. Do you allow engine activation?”

The third-party device displays the message and presents options such as “Approve” and “Deny.” When the third party selects an option, the device sends approval information or denial information back to the server. The server receives this information and incorporates the result into the control information. If approval is not granted within a defined time window, the server maintains a prohibition state and does not send a permission signal to the control device.

This structure improves computer technology in several ways. The server reduces communication load by transmitting compact feature sets and structured summaries to the generative AI model rather than full raw streams, thus lowering bandwidth and latency. The server improves processing speed by performing early feature extraction at the terminal, thereby reducing the computational cost on the server side and enabling near real-time decision making. The integration of a trained information processing model with a generative AI model through explicitly designed prompt sentences allows the server to achieve higher decision accuracy and better robustness to noisy data compared with conventional rule-based systems. Because the generative AI model is used with strict prompt control and structured feature representations, the server can treat the generative AI model as a specialized, parameterized component in a deterministic pipeline rather than as a generic black-box text generator.

The server not only automates human work but also performs new forms of data fusion and predictive modeling that are difficult for a human operator to execute consistently and in real time. For instance, the server computes high-dimensional representations of combined voice and visual features, uses trained non-linear mapping functions, and continuously updates risk assessments as new data arrives. By doing so, the server reduces error rates in detecting unsafe driving conditions and prevents both false locks and missed detections.

Alternative embodiments are also possible. In one embodiment, the terminal may implement part of the trained information processing model, for example a lighter neural network optimized for on-device inference, while the server focuses on handling generative AI interactions and third-party communication. In another embodiment, the generative AI model may operate as a local model on the server hardware or as a distributed model across multiple server instances. In yet another embodiment, the feature fusion module may use a recurrent architecture to account for temporal sequences of driver-state features, and the comprehensive risk index may be computed as a function of both current and past states.

In all these embodiments, the server, the terminal, and the control device cooperate as a tightly coupled technical system. The system operates on specific data structures, employs concrete algorithms and model architectures, and produces control signals that directly alter the behavior of physical hardware in the vehicle environment. Through these mechanisms, the invention realizes an improvement in computer-implemented driver-state evaluation and vehicle control, yielding measurable gains in precision, robustness, and computational efficiency compared with conventional threshold-based systems.

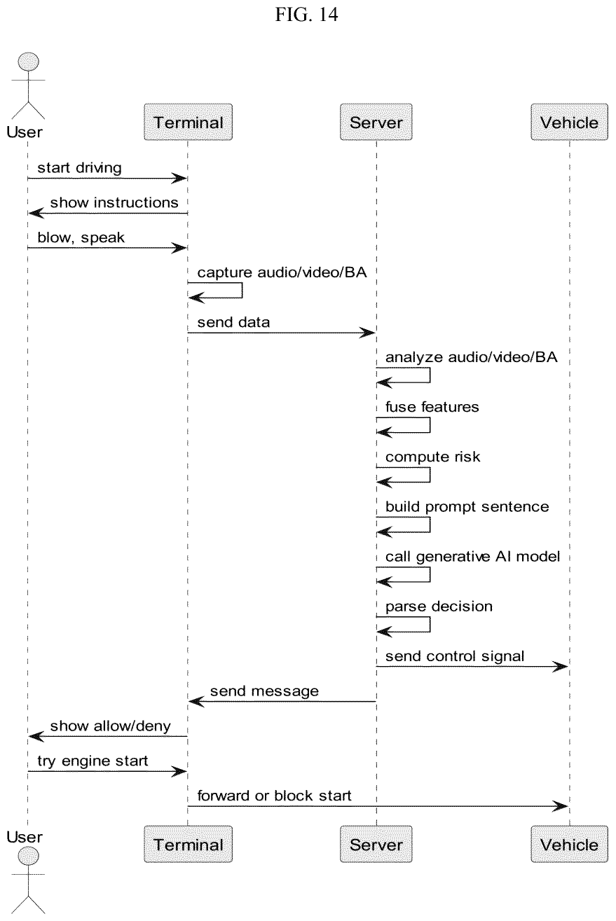

The following describes the processing flow using FIG. 14.

### Step 1:

Terminal activates monitoring and acquires raw sensor data.

Terminal starts a monitoring application when the user sits in the driver seat or when ignition is requested. Terminal turns on a microphone, a camera directed at the user's face, and a breath alcohol sensor, and displays instructions such as “Please blow into the sensor and answer the following questions.” User blows into the sensor and answers spoken questions.

Input: analog audio signal from the microphone, analog optical signal from the camera, analog or digital signal from the alcohol sensor, and timestamps of question prompts.

Output: digitized audio samples, digitized image frames of the user's face and eyes, numeric alcohol concentration values, and a log of question and response timestamps.

Terminal converts analog signals into digital data using an analog-to-digital converter, stores these data in buffers, and associates each sensor sample with a timestamp for later synchronization.

### Step 2:

Terminal performs local preprocessing and feature extraction.

Terminal segments the audio stream into utterances corresponding to user responses by detecting when the audio energy exceeds a noise threshold. Terminal identifies the onset of each response and computes a response time by subtracting the question display timestamp from the detected onset timestamp. Terminal uses basic audio feature extraction to compute features such as short-time energy, pitch estimate, and speaking rate. Terminal also applies a face detection routine to each image frame to crop the facial region and normalize brightness and contrast.

Input: digitized audio samples, image frames, alcohol concentration values, and timestamps from Step 1.

Output: local feature set including preliminary response times, coarse audio features, cropped and normalized face images, and the alcohol concentration values.

Terminal performs data processing by applying mathematical operations such as energy calculation (sum of squared samples), peak detection for onset, resampling of images to a fixed resolution, and simple normalization of pixel intensity values.

### Step 3:

Terminal packages structured data and sends it to the server.

Terminal constructs a structured record that includes the local feature set, the raw or compressed audio segments, the cropped face images, the alcohol concentration values, and metadata such as session ID and timestamps. Terminal establishes a wireless connection to the server and transmits this record using a network protocol.

Input: local feature set and raw or compressed sensor data from Step 2.

Output: one or more structured data packets transmitted to the server.

Terminal performs data processing by encoding the structured record into a serialized format, compressing audio and image data when needed, and scheduling packet transmission over a wireless link.

### Step 4:

Server receives data and performs detailed audio analysis.

Server receives the structured packets, stores them temporarily in memory, and extracts the audio segments and local audio features. Server applies a signal processing pipeline that computes mel-frequency cepstral coefficients and pitch contours, and then applies a speech recognition engine to convert the audio into text. Server measures speech clarity by calculating phoneme duration statistics, error rates in recognized phonemes, and instability in pitch.

Input: audio segments, preliminary response times, and coarse audio features from Step 3.

Output: detailed audio feature set including refined response times, a speech clarity index, a voice pattern description (for example, pitch variability, rhythm), and recognized text.

Server performs data processing by executing algorithms such as Fourier transforms, filter bank computations, and decoding of a speech model, and then aggregates numeric measures into the detailed audio feature set.

### Step 5:

Server performs detailed image analysis and eye-movement evaluation.

Server extracts face images from the received packets and applies a face and eye localization algorithm. Server tracks the eye regions across consecutive frames using an optical flow or template matching method, computes gaze direction vectors, and calculates gaze stability as a variance of those vectors over time. Server identifies blinks by detecting rapid changes in eyelid openness and counts them per unit time to compute a blink frequency.

Input: cropped and normalized face images and associated timestamps from Step 3.

Output: eye-movement evaluation information including gaze direction, gaze stability, blink frequency, and eyelid openness measures.

Server performs data processing by executing pixel-wise convolution operations, motion estimation between frames, and statistical calculations on detected eye features to derive quantitative eye-movement descriptors.

### Step 6:

Server fuses multimodal features and computes a drinking influence value.

Server collects the detailed audio feature set from Step 4, the eye-movement evaluation information from Step 5, the alcohol concentration values from Step 1, and relevant history information from a database. Server normalizes each feature dimension by subtracting pre-computed means and dividing by standard deviations. Server concatenates the normalized features into a single feature vector and inputs this vector into a trained neural network model. The neural network propagates the input through multiple layers to produce an output representing a probability of drinking and an influence degree due to drinking.

Input: normalized audio features, eye-movement features, alcohol concentration values, and history information.

Output: evaluation values including a drinking probability and a numeric influence degree.

Server performs data processing by executing matrix multiplications, activation functions, and output scaling within the neural network, using the learned weights and biases to transform the input feature vector into the evaluation values.

### Step 7:

Server evaluates the emotional state and adjusts the risk contribution.

Server extracts facial expression features (such as eyebrow curvature, mouth shape, and facial muscle tension) and prosodic voice features (such as pitch variance and speaking rate) from the same image and audio data. Server feeds these features into an emotion classifier, which may be another neural network, to obtain an emotion label (for example, anger, anxiety, or calmness) and an emotional intensity score. Server maps the emotional intensity to an adjustment factor that will increase or decrease the drinking influence degree when certain emotions are present.

Input: facial expression features and prosodic voice features derived from Steps 4 and 5.

Output: emotional state classification, emotional intensity score, and a numeric adjustment factor for the drinking influence degree.

Server performs data processing by running classification computations over the emotion model, then applying a predefined mapping (for example, table lookup or linear scaling) from emotion and intensity to the adjustment factor.

### Step 8:

Server computes a comprehensive risk index.

Server combines the drinking influence degree from Step 6 and the adjustment factor from Step 7 to obtain an adjusted influence degree. Server incorporates additional factors such as prior risk scores, time of day, or frequency of past incidents, and computes a comprehensive risk index as a weighted combination of these components. Server sets the weights based on calibration or learning so that certain features, like high alcohol concentration and strong anger, have a greater impact on the index.

Input: drinking influence degree, adjustment factor, emotional state information, and contextual or historical data.

Output: a comprehensive risk index representing overall drivability safety.

Server performs data processing by multiplying each component by its corresponding weight, summing the weighted components, and optionally passing the sum through a non-linear function to normalize the index to a specified range.

### Step 9:

Server constructs a prompt sentence and queries the generative AI model.

Server generates a prompt sentence that explicitly describes the driver's current features and asks for a decision and explanation. For example, server constructs a text such as:
“Given these driver features: response time=1.4 seconds, speech clarity index=0.6, blink frequency=32 per minute, gaze stability=low, breath alcohol concentration=0.05, and emotional state=anger, determine whether engine activation should be allowed, and explain the reasons.”

Server appends formatted feature values to the prompt sentence as readable text and sends this composite text to the generative AI model.

Input: comprehensive risk index, audio and eye-movement feature values, and emotional state classification from previous steps.

Output: a textual response from the generative AI model including a recommended decision (for example, allow or deny engine activation) and a natural-language explanation.

Server performs data processing by encoding the features into textual form, transmitting them to the generative AI model, receiving the generated text, and storing the response for subsequent parsing.

### Step 10:

Server parses the generative AI output and refines control information.

Server analyzes the textual output from Step 9 to extract a structured decision and explanation. Server identifies key phrases such as “engine activation should be denied” or “engine activation may be allowed with caution” and maps these phrases to internal control codes. Server then uses these control codes, together with the comprehensive risk index, to generate or refine control information specifying whether to permit or prohibit activation of the energy conversion device, whether to enable an automatic driving function, and whether to request third-party confirmation.

Input: generative AI textual output and comprehensive risk index from Step 8.

Output: refined control information including engine lock state, automatic driving activation state, and third-party confirmation requirement.

Server performs data processing by applying pattern-matching or simple natural-language parsing to the generative AI output, and then combining the parsed decision with numeric thresholds to create a consistent set of control flags.

### Step 11:

Server outputs control information to the terminal and the vehicle control device.

Server sends a control signal to the control device for the energy conversion device, representing at least one of a lock state, an unlock state, or an automatic driving enable state.

Server also sends a message to the terminal that contains alert information or driving prohibition information and the explanation derived from the generative AI model.

Input: refined control information from Step 10.

Output: digital command signals sent to the control device, and user-facing messages sent to the terminal.

Server performs data processing by translating internal control flags into a protocol-specific message format for the vehicle bus or wireless link, and into a display message format for the terminal, then initiating the transmission of these messages.

### Step 12:

Terminal displays feedback and enforces engine activation behavior.

Terminal receives the user-facing message and presents it on a display or via a speaker.

Terminal informs the user, for example, “Engine start is blocked because your current state is high risk,” or “Engine start is permitted. Please drive carefully.” Terminal also enforces the received engine lock or unlock state by either allowing the user's engine start request to be forwarded, or by intercepting and rejecting the request.

Input: user-facing message and engine control state from Step 11.

Output: visual or auditory presentation to the user, and an effective permission or prohibition of engine start at the terminal interface level.

Terminal performs data processing by rendering text or audio on the output devices and by checking the engine control state before passing any start command to the vehicle's control device.

### Step 13:

Server handles third-party confirmation when required.

Server checks whether the control information from Step 10 requires third-party confirmation. If confirmation is required, server composes an approval request containing a brief summary of the driver's state and sends it to a third-party information processing device via a communication channel. The request may include text such as “The driver appears to be under the influence. Do you approve engine activation?” The third party responds by selecting an approval or denial option.

Input: refined control information indicating third-party requirement, and contact information for the third party.

Output: approval request message sent to the third-party device, and, later, approval information or denial information received from that device.

Server performs data processing by formatting the request message, addressing it to the appropriate device, transmitting it through the communication interface, and then receiving and interpreting the response as a binary approval or denial flag.

### Step 14:

Server updates control state based on third-party response.

Server receives the approval information or denial information from Step 13. If approval is granted, server updates control information to allow engine activation under certain conditions; if denial is received or no response is obtained within a timeout period, server maintains or sets a prohibition state. Server then notifies the terminal of the third-party decision and updates the explanation message if necessary.

Input: approval information or denial information from the third-party device.

Output: updated control information and updated user-facing messages.

Server performs data processing by setting or clearing internal flags based on the response, recomputing any dependencies (for example, lifting a lock only when both risk index and approval allow it), and constructing follow-up messages to be sent to the terminal.

### Step 15:

Terminal and user interact in response to updated control state.

Terminal receives the updated control information and messages and presents them to the user. If engine activation remains prohibited, terminal explains that a third party has denied or not provided approval. If activation is now permitted, terminal informs the user that engine start is allowed. User may then decide to start the engine, request a ride from someone else, or leave the vehicle.

Input: updated user-facing messages and control information from Step 14.

Output: final user notification and, depending on user action, a start request signal or no start attempt.

Terminal and user perform actions based on the technical state: the terminal checks the control state when the user attempts to start the engine, and the user either successfully starts the engine when allowed or receives a blocked response when prohibited.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like.

The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

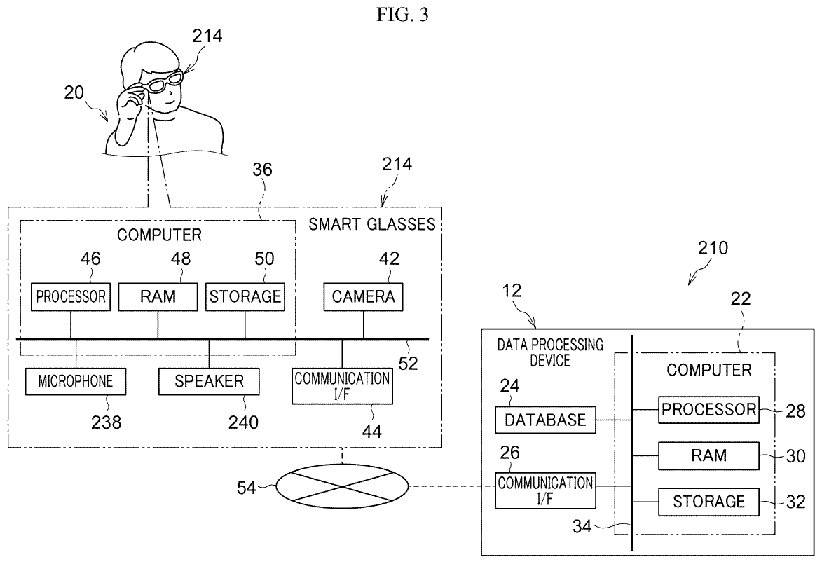

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

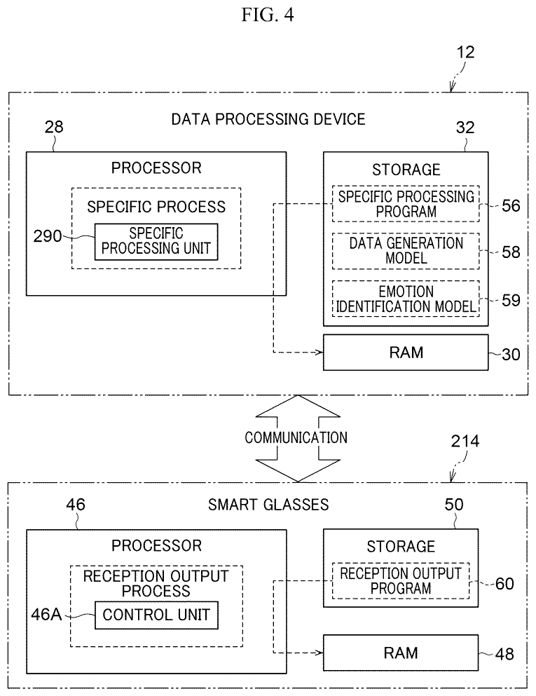

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

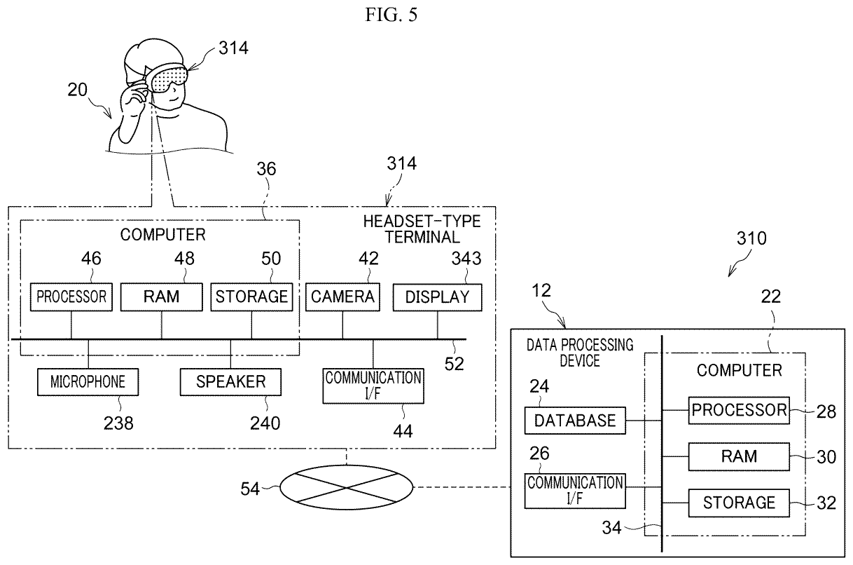

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

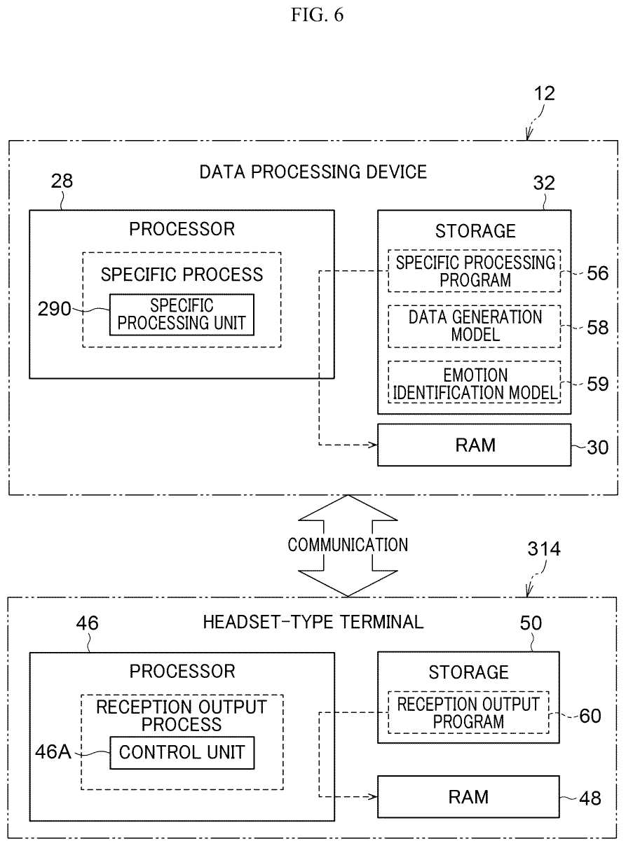

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314.

In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

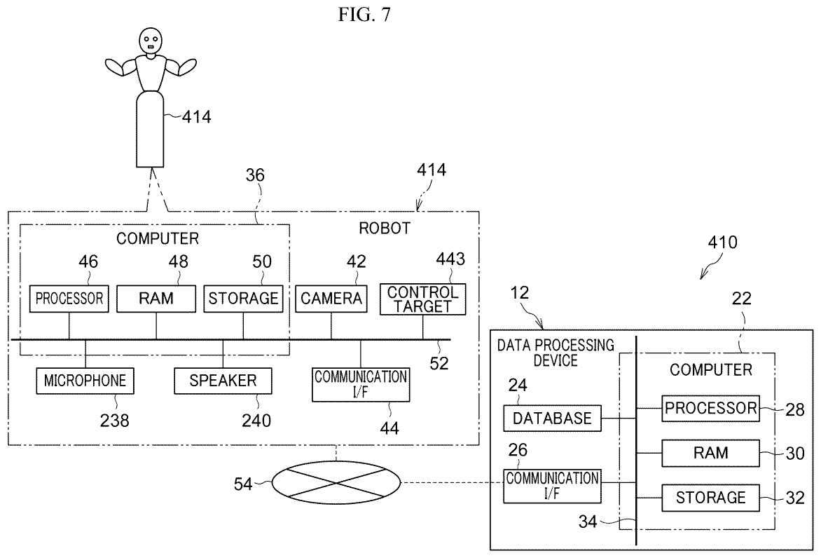

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

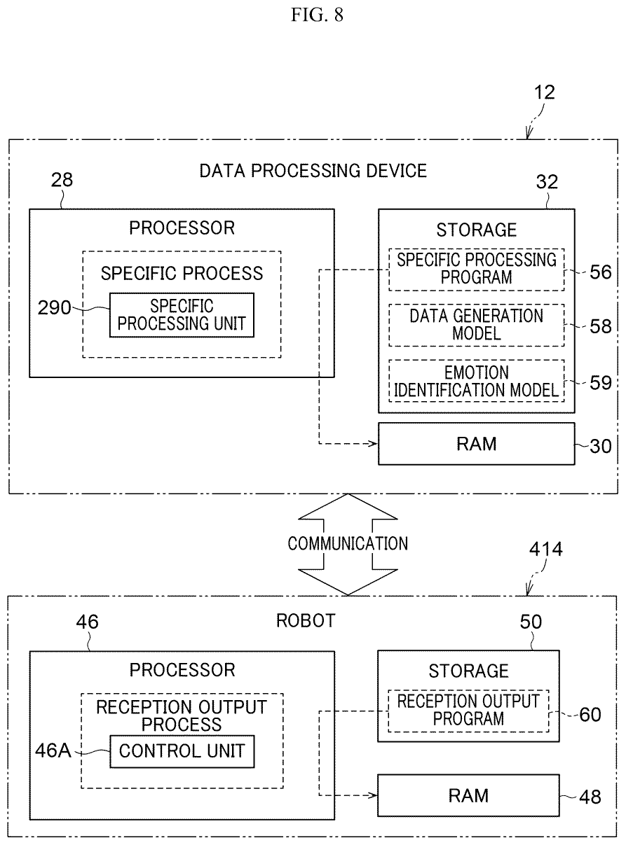

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

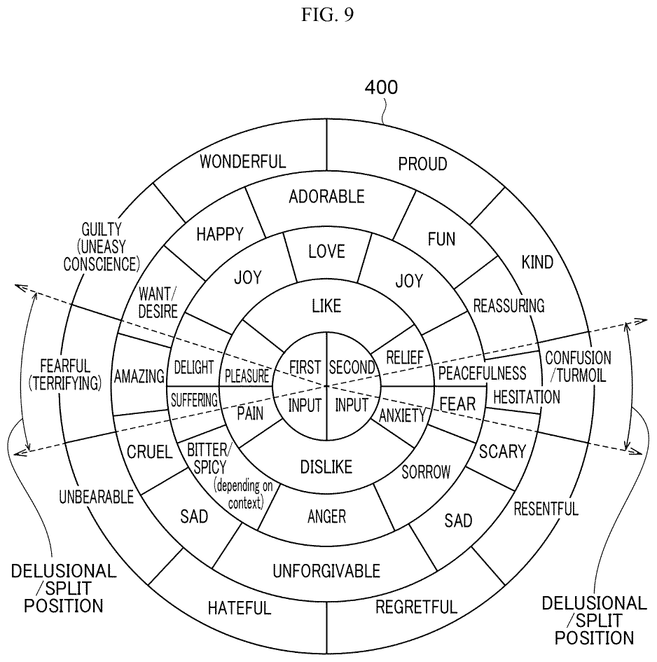

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

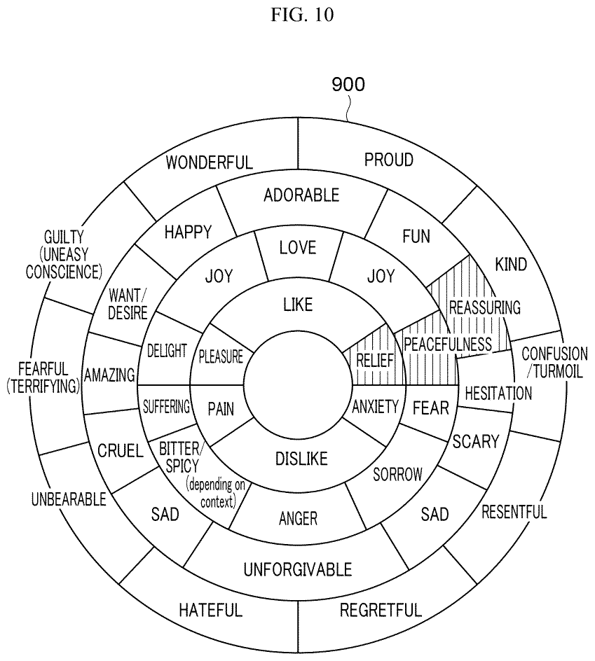

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire acoustic information of a driver from an audio input device and execute a speech recognition process to convert the acoustic information into character information and time information, and to calculate a reaction time and a speech clarity value based on the character information and the time information,
acquire image information including an eye region of the driver from an image acquisition device and perform image processing on the image information to detect the eye region, and to calculate a blink frequency and a gaze direction variation amount based on position changes of an eyelid and a pupil,
synchronize the reaction time, the speech clarity value, the blink frequency, and the gaze direction variation amount on a common time axis, and generate, for each of predetermined time intervals, a feature vector including the reaction time, the speech clarity value, the blink frequency, and the gaze direction variation amount,
input the feature vector into a machine learning model and output, from the machine learning model, a determination result regarding a presence or absence of intoxication of the driver and a degree of influence of the intoxication,
format evaluation information including the determination result and the feature vector into a text representation, attach a prompt sentence that instructs a generative AI model to generate an explanation of the evaluation information, transmit the text representation and the prompt sentence to the generative AI model, and obtain, from the generative AI model, an explanatory text regarding a state of the driver, and
generate control information indicating whether activation of a power unit of a vehicle is permitted or prohibited in accordance with the determination result, and transmit the control information to a safety mechanism so as to control the safety mechanism such that the power unit is not activated solely by an operation of the driver.

### (Supplementary 2)

The system according to supplementary 1,
wherein the processor is configured to generate a prompt sentence for inputting emotion-related feature values extracted from the acoustic information and the image information of the driver into an emotion evaluation function included in the generative AI model, and to correct the degree of influence of the intoxication in the determination result of supplementary 1 based on an emotion state evaluation result obtained from the generative AI model.

### (Supplementary 3)

The system according to supplementary 1,
wherein the processor is configured to present warning information to the driver using the determination result of supplementary 1 and the explanatory text obtained from the generative AI model, request acquisition of confirmation information from a third party under a predetermined condition, and maintain a prohibition state of activation of the power unit by the safety mechanism when the driver is evaluated as being under the influence of intoxication in the determination result of supplementary 1.

### Application Example 1

### (Supplementary 1)

A system comprising a processor,
wherein the processor is configured to
acquire acoustic information and image information of a driver from a terminal device mounted in a moving body,
divide the acquired acoustic information into sections based on time information, calculate a response reaction time of the driver based on a difference between a start timing of each section and a transmission timing of query information transmitted from the processor to the terminal device, and store the calculated response reaction time in association with time-series information,
convert each divided section of the acoustic information into character information by performing speech recognition processing, extract acoustic feature quantities including utterance speed, pause duration, repetition of words, frequency of self-corrections, volume fluctuation, fundamental frequency, and spectral feature quantities from the character information and the acoustic information, and evaluate clarity of utterance and an utterance pattern of the driver based on the extracted acoustic feature quantities,
analyze the acquired image information to detect a face region and an eye region of the driver, calculate at least one of a blink count, a blink duration, an eyelid opening degree, and a variation of a gaze direction in the eye region, and calculate an attention state index and an eye-movement abnormality index of the driver based on the calculated values,
normalize the response reaction time, a result of evaluating the clarity of utterance and the utterance pattern, and the attention state index and the eye-movement abnormality index, and integrate the normalized values by using a machine learning algorithm so as to calculate a risk index indicating presence or absence of alcohol consumption by the driver and a degree of influence of the alcohol consumption on a driving ability of the driver,
generate warning information when the risk index exceeds a predetermined reference value, transmit control information to the terminal device so as to cause the terminal device to output the warning information to the driver, and, when necessary, transmit control information related to speed reduction and stopping to a moving body control device, record, in association with time-series information, feature quantities obtained from the acoustic information and the image information and the risk index, and compare the recorded feature quantities and the risk index with a reference state for each driver so as to dynamically correct at least one of the risk index and the predetermined reference value, and generate a prompt sentence for a generative information processing model, the prompt sentence instructing the generative information processing model to design or update an algorithm for estimating the presence or absence of the alcohol consumption and the degree of influence by using the response reaction time, the clarity of utterance, the utterance pattern, and eye-movement indices, and adjust at least one of the machine learning algorithm and the predetermined reference value based on a result obtained from the generative information processing model.

### (Supplementary 2)

The system according to supplementary 1,
wherein the processor is configured to
extract, from the acoustic information and the image information, feature quantities including at least one of intensity of voice, speaking rate, vocabulary pattern, facial expression, and eye-movement pattern, calculate an emotional state index of the driver by using an emotional state estimation algorithm based on the extracted feature quantities, correct at least one of a weight or a threshold of the risk index according to supplementary 1 based on the emotional state index, generate a prompt sentence for the generative information processing model instructing design or update of the emotional state estimation algorithm, and improve the emotional state estimation algorithm by using the generative information processing model.

### (Supplementary 3)

The system according to supplementary 1,
wherein the processor is configured to
determine, based on the risk index according to supplementary 1 and the emotional state index according to supplementary 2, a warning level to the driver in a stepwise manner, perform notification by visual information or auditory information for a low-level warning, attempt notification to and consent acquisition from a third-party terminal device for a high-level warning, and, when consent information or impossibility-of-consent information is received from the third-party terminal device, control a safety mechanism including at least one of prohibition of start of a power generation device of the moving body, limitation of output of the power generation device, and automatic stopping of the moving body, and use contents of the third-party notification and the safety mechanism control as a prompt sentence for the generative information processing model so as to optimize future warning output conditions and safety mechanism control conditions.

### Example 2

### (Supplementary 1)

A system comprising a processor,
wherein the processor is configured to
acquire audio information and visual information of a driver, generate a prompt sentence for instructing a generative AI model to analyze reaction speed, speech state, and audio patterns, and determine presence and degree of alcohol influence on the driver based on an analysis result from the generative AI model,
acquire numerical information from a detection device configured to detect an alcohol concentration in breath of the driver, and determine whether the driver is under alcohol influence by comparing the numerical information with a reference value,
integrate an analysis result of the audio information and the visual information with a comparison result of the alcohol concentration, and evaluate presence and degree of alcohol influence on the driver comprehensively by using machine learning,
based on the comprehensive evaluation, when the driver is determined to be under alcohol influence, transmit notification information to a third-party terminal via a communication function, receive response information from the third-party terminal, and determine presence or absence of consent,
generate control information indicating permission or prohibition of activation of a power unit of a vehicle according to the presence or absence of the consent and the comprehensive evaluation, transmit the control information to a control device of the vehicle, and operate a safety mechanism in which the power unit is not activated by the driver alone,
and record the notification information, the response information, the evaluation result, and the control information as a history, generate a prompt sentence for input to a generative AI model for generating an explanatory text of an operation situation based on the history, and acquire the explanatory text output from the generative AI model.

### (Supplementary 2)

The system according to supplementary 1,
wherein the processor is configured to
generate a prompt sentence for instructing a generative AI model to evaluate an emotional state of the driver in order to analyze the emotional state, acquire an evaluation result of the emotional state from the generative AI model, and correct the comprehensive evaluation of the alcohol influence degree based on the evaluation result of the emotional state.

### (Supplementary 3)

The system according to supplementary 1,
wherein the processor is configured to
when the response information from the third-party terminal is not obtained within a predetermined time, generate control information for prohibiting activation of the power unit, and present, to the driver or the third party, an explanatory text including the alcohol influence degree, the presence or absence of the consent, and a reason for permission or prohibition of activation of the power unit, based on the history.

### Application Example 2

### (Supplementary 1)

A system comprising a processor,
wherein the processor is configured to
acquire voice information of a driver, generate a prompt sentence for instructing a generative AI model to perform processing for extracting, from the voice information, response time, speech clarity, and voice features of the driver, input the prompt sentence and the voice information to the generative AI model, and obtain voice evaluation information including the response time, the speech clarity, and the voice features,
acquire image information of the driver, and generate eye-movement evaluation information by using an image processing method to extract, from the image information, features relating to gaze direction, blink frequency, and movements around eyes,
integrate the voice evaluation information and the eye-movement evaluation information with alcohol concentration information of breath of the driver and history information indicating a state of the driver, and calculate an evaluation value indicating presence or absence of drinking of the driver and an influence degree due to drinking of the driver by using a trained information processing model,
calculate a comprehensive risk index indicating drivability safety of the driver on the basis of the evaluation value indicating the influence degree due to drinking and state information including an emotional state of the driver, and generate control information for determining, in accordance with the comprehensive risk index, at least one of permission or prohibition of activation of an energy conversion device, an operating state of an automatic driving function, and necessity of third-party confirmation,
generate a prompt sentence for instructing the generative AI model to generate, on the basis of the comprehensive risk index and a feature set including the voice evaluation information and the eye-movement evaluation information, a decision and an explanation relating to permission or prohibition of activation for the driver and necessity of third-party confirmation, input the prompt sentence together with structured data summarizing the feature set to the generative AI model, and correct the control information on the basis of the decision and the explanation obtained from the generative AI model, and
output, on the basis of the control information, alert information or driving prohibition information to the driver via an information display device, transmit approval request information to a third party information processing device via a communication device, and output a control signal to a control device for the energy conversion device so as to realize at least one of a state in which the energy conversion device is not activated by the driver alone, a state in which the automatic driving function operates preferentially, and a state in which activation of the energy conversion device is permitted.

### (Supplementary 2)

The system according to supplementary 1,
wherein the processor is configured to
generate a prompt sentence for instructing the generative AI model to perform classification of the emotional state of the driver and calculation of a correction amount for the influence degree due to drinking, on the basis of state information including facial expression features and voice features extracted from the image information and the voice information of the driver and on the basis of the feature set used for calculation of the comprehensive risk index, input the prompt sentence and the state information to the generative AI model, and reflect an emotional state evaluation result and the correction amount obtained from the generative AI model in the calculation processing of the comprehensive risk index.

### (Supplementary 3)

The system according to supplementary 1,
wherein the processor is configured to
obtain approval information or denial information input from the third-party information processing device when, on the basis of the control information, the driver is determined to be in a state under influence of drinking or in an emotionally unstable state, output an activation prohibition control signal to the control device for the energy conversion device unless the approval information is obtained, and update warning content and report content for the driver on the basis of contents of the approval information or the denial information and the explanation obtained from the generative AI model.

What is claimed is:

1. A system comprising:
circuitry configured to:
acquire acoustic information of an operator from an audio input device and execute speech recognition processing to convert the acoustic information into character information and time information, and calculate a reaction time and a speech clarity value based on the character information and the time information;
acquire, via a communication interface coupled to a packet-switched network, image information including an eye region of the operator from an image acquisition device, perform image processing on the image information to detect the eye region, and calculate a blink frequency and a gaze direction variation amount based on position changes of an eyelid and a pupil;
synchronize the reaction time, the speech clarity value, the blink frequency, and the gaze direction variation amount on a common time axis, and generate, for each of predetermined time intervals, a feature vector comprising the reaction time, the speech clarity value, the blink frequency, and the gaze direction variation amount;
input the feature vector into a machine learning model and output a determination result regarding a presence or absence of an impairment condition of the operator and a degree of influence of the impairment condition;
format evaluation information comprising the determination result and the feature vector into a text representation, attach a prompt sentence that instructs a generative neural network model to generate an explanation of the evaluation information, transmit the text representation and the prompt sentence to the generative neural network model, and obtain an explanatory text regarding a state of the operator; and
generate control information indicating whether activation of a power unit is permitted or prohibited in accordance with the determination result, and transmit the control information as a notification data packet to a safety mechanism so as to control the safety mechanism such that the power unit is not activated solely by an operation of the operator.

2. The system according to claim 1, wherein the circuitry is configured to generate a prompt sentence for inputting emotion-related feature values extracted from the acoustic information and the image information into an emotion evaluation function of the generative neural network model, and to correct the degree of influence in the determination result based on an emotional state evaluation result obtained from the generative neural network model.

3. The system according to claim 2, wherein the circuitry is configured to distinguish between emotional state changes and impairment-induced changes in the feature vector by comparing the emotion-related feature values with impairment-specific patterns stored in a storage device.

4. The system according to claim 1, wherein the circuitry is configured to present warning information to the operator using the determination result and the explanatory text, request acquisition of confirmation information from a third party under a predetermined condition, and maintain a prohibition state of activation of the power unit when the operator is determined to be under influence of the impairment condition.

5. The system according to claim 4, wherein the circuitry is configured to transmit the warning information and a confirmation request to a third-party terminal device via the communication interface, receive confirmation data from the third-party terminal device, and release the prohibition state only upon receipt of the confirmation data.

6. The system according to claim 1, wherein the speech recognition processing comprises dividing the acoustic information into sections based on time information, calculating a response reaction time based on a difference between a start timing of each section and a transmission timing of query information, and extracting acoustic feature quantities comprising at least utterance speed, pause duration, repetition of words, frequency of self-corrections, and volume fluctuation.

7. The system according to claim 6, wherein the acoustic feature quantities further comprise a fundamental frequency contour and spectral feature quantities, and wherein the circuitry is configured to evaluate clarity of utterance and an utterance pattern based on the extracted acoustic feature quantities.

8. The system according to claim 1, wherein the image processing comprises detecting a face region using a face detection model, extracting the eye region from the face region, calculating at least one of a blink count, a blink duration, an eyelid opening degree, or a saccade frequency, and computing the gaze direction variation amount as a statistical measure of gaze stability over a time window.

9. The system according to claim 1, wherein the machine learning model comprises a classification model trained on labeled feature vectors, and wherein the determination result comprises a classification label and a confidence score indicating probability of the impairment condition.

10. The system according to claim 9, wherein the circuitry is configured to compare the confidence score with a plurality of threshold values to classify the impairment condition into a plurality of severity levels.

11. The system according to claim 1, wherein the generative neural network model comprises a transformer-based architecture including multiple self-attention layers and feed-forward layers, and wherein the explanatory text comprises at least a description of detected indicators, an assessed severity, and a recommended action.

12. The system according to claim 1, wherein the circuitry is configured to store the feature vector, the determination result, and the explanatory text in a storage device as history information in association with a timestamp and an operator identifier.

13. The system according to claim 12, wherein the circuitry is configured to analyze the history information over a plurality of sessions to detect a temporal trend in the feature vector and to adjust sensitivity parameters of the machine learning model based on the detected trend.

14. The system according to claim 1, wherein the audio input device and the image acquisition device are mounted in a moving body, and the circuitry is configured to acquire the acoustic information and the image information in real time during operation of the moving body.

15. The system according to claim 14, wherein the circuitry is configured to transmit query information to the operator via a speaker of the moving body, measure a time interval between the query information and a detected response onset in the acoustic information, and use the time interval as the reaction time.

16. The system according to claim 1, wherein the circuitry is configured to generate an interactive dialogue with the operator by transmitting a series of query sentences and receiving corresponding acoustic responses, and to calculate the feature vector based on a progression of the reaction times and clarity values across the series.

17. The system according to claim 1, wherein the circuitry is configured to apply information-protection processing comprising at least encryption and access control to the acoustic information, the image information, and the determination result.

18. A system comprising:
circuitry configured to:
acquire, via a communication interface coupled to a packet-switched network, acoustic information from an audio input device and image information from an image acquisition device of a moving body, execute speech recognition processing to calculate a reaction time and a speech clarity value from the acoustic information, and perform image processing to calculate a blink frequency and a gaze direction variation amount from the image information;
synchronize the reaction time, the speech clarity value, the blink frequency, and the gaze direction variation amount on a common time axis to generate a feature vector, and input the feature vector into a machine learning model to output a determination result comprising a classification label and a confidence score regarding an impairment condition;
extract emotion-related feature values from the acoustic information and the image information, input a prompt sentence comprising the emotion-related feature values to a generative neural network model comprising a transformer-based architecture, obtain an emotional state evaluation, and correct the determination result based on the emotional state evaluation;
format the determination result and the feature vector into a text representation, input the text representation with a prompt sentence to the generative neural network model, and obtain an explanatory text comprising detected indicators, an assessed severity, and a recommended action; and
generate control information indicating whether activation of a power unit is permitted or prohibited, transmit the control information as a notification data packet to a safety mechanism, and transmit the explanatory text to a terminal device of the operator.

19. The system according to claim 18, wherein the circuitry is configured to present warning information to the operator, request confirmation from a third-party terminal device via the communication interface, and maintain a prohibition state of the power unit until confirmation data is received from the third-party terminal device.

20. A method comprising:
acquiring acoustic information of an operator from an audio input device and executing speech recognition processing to calculate a reaction time and a speech clarity value;
acquiring, via a communication interface coupled to a packet-switched network, image information including an eye region of the operator from an image acquisition device, performing image processing to calculate a blink frequency and a gaze direction variation amount;
synchronizing the reaction time, the speech clarity value, the blink frequency, and the gaze direction variation amount on a common time axis, and generating a feature vector for each of predetermined time intervals;
inputting the feature vector into a machine learning model and outputting a determination result regarding a presence or absence of an impairment condition and a degree of influence;
formatting evaluation information comprising the determination result and the feature vector, attaching a prompt sentence instructing a generative neural network model to generate an explanatory text, and obtaining the explanatory text; and
generating control information indicating whether activation of a power unit is permitted or prohibited in accordance with the determination result, and transmitting the control information as a notification data packet to a safety mechanism.
